(19) United States
(12) Patent Application Publication
(10) Pub. No.: US 2007/0043178 A1
(43) Pub. Date: Feb. 22, 2007

(54) Water-soluble polymer and its production process and uses

(76) Inventors: Akihiko Kanzaki, Osaka (JP); Akiko Hemmi, Osaka (JP); Yoshikazu Fujii, Osaka (JP); Shigeru Yamaguchi, Osaka (JP)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 10/557,828

(22) PCT Filed: Jun. 10, 2004
(86) PCT No.: PCT/JP04/08506

§ 371 Date: Nov. 21, 2005

(30) Foreign Application Priority Data
Jun. 12, 2003 (JP) 2003-168212

(51) Int. Cl. C08G 61/02; C08F 2/00

(52) U.S. Cl. 526/68; 523/1

(57) ABSTRACT

An object of the present invention is to provide: a water-soluble polymer which can exercise a high calcium-ion-binding ability and a high clay dispersibility even under circumstances where high-hardness water is used; and a process for producing such a water-soluble polymer with ease and good productivity. As a means of achieving this object, the water-soluble polymer according to the present invention has: (1) a calcium-ion-binding ability of not less than 470 mgCaCO₃/g and further a clay dispersibility of not less than 0.90 in a test liquid having a calcium concentration of 50 ppm in terms of calcium carbonate; or (2) a calcium-ion-binding ability of not less than 430 mgCaCO₃/g and further a clay dispersibility of not less than 0.70 in a test liquid having a calcium concentration of 100 ppm in terms of calcium carbonate.

### TECHNICAL FIELD

The present invention relates to: a water-soluble polymer having specific functions; and its production process and uses. Specifically, the present invention relates to a water-soluble polymer and its production process and uses, wherein the water-soluble polymer combines a high chelating ability (calcium-ion-binding ability) and a high inorganic-particles dispersibility (clay dispersibility) and is therefore usable for uses such as detergent compositions.

### BACKGROUND ART

As a surfactant being a main component of such as detergent composition, an anionic surfactant has hitherto mainly been used. Hereupon, the detergent composition refers to not only a detergent itself being an end product, but also an intermediate product being a precursor of the detergent.

If hardness components such as calcium ion and magnesium ion are present, then the anionic surfactant unfavorably forms salts with them to thus become insoluble, so that the effects (e.g. detergency) of the anionic surfactant greatly deteriorate. Thus, in order to beforehand bind the above hardness components, for example, a water-soluble polymer having a high calcium-ion-binding ability is added as a builder to the detergent. As the above water-soluble polymer, with consideration given also to uses for such as detergent compositions, there is used a water-soluble polymer which has a function (clay dispersibility) to disperse inorganic particles (which cause such as mud dirt) into water. The height of the clay dispersibility finds its expression remarkably in a redeposition-inhibiting function upon white cloth.

As a polymer having these calcium-ion-binding ability and clay dispersibility, there is known a water-soluble polycarboxylic polymer as being characteristic.

This polymer is used for a wide range of other uses such as dispersants, flocculants, scale inhibitors, chelating agents, and fiber-treating agents besides the above uses such as detergent compositions (e.g. refer to patent document 1 below).

Examples of the water-soluble polycarboxylic polymer include acrylic polymers (e.g. refer to patent documents 2 to 3 below) and maleic/acrylic copolymers (e.g. refer to patent documents 4 to 7 below). These exercise excellent performances in the calcium-ion-binding ability and the clay dispersibility and are useful for the above various uses.

In recent years, as new improvements and developments to obtain excellent builders are made one after another due to various new knowledge and technical progress in the production of the aforementioned water-soluble polymers, the use of the water-soluble polymers is extending to a further wider range of use circumstances that have never been supposed so far. In such a situation, the needs of users' side are also rapidly migrating toward desiring to obtain a water-soluble polymer which can exercise still higher performances in the calcium-ion-binding ability and the clay dispersibility. Specifically, the use of water-soluble polymers has extended as far as every corner of the world. As a result, it is becoming necessary to consider use circumstances where water having a comparatively high hardness (high-hardness water) is used, such where the concentrations of such as calcium ion in water being used are still higher than before.

In order to cope with such rise of the hardness, it is strongly desired, in combination also with demands from such as environmental aspects and cost aspects, that the water-soluble polymer (builder) can be used not simply in an amount increased so as to be appropriate for the height of the hardness, but, if possible, in the same amount as before, or in a ratio decreased as much as possible relative to the hardness. Thus, there is demanded a water-soluble polymer which can exercise not lower performances both in the calcium-ion-binding ability and the clay dispersibility when used in a smaller amount than when used in an increased amount as before.

[Patent Document 1] JP-A-035989/1999 (Kokai)

[Patent Document 2] JP-A-270605/1987 (Kokai)

[Patent Document 3] JP-A-239114/1993 (Kokai)

[Patent Document 4] JP-A-247143/1993 (Kokai)

[Patent Document 5] JP-B-002167/1991 (Kokoku)

[Patent Document 6] JP-B-014046/1991 (Kokoku)

[Patent Document 7] Japanese Patent No. 2574144

However, there has never been a useful water-soluble polymer which can satisfy the aforementioned needs in both performances of the calcium-ion-binding ability and the clay dispersibility. For example, if an attempt is made to obtain a water-soluble polymer which can exercise the aforementioned high performance in the calcium-ion-binding ability, then its molecular weight must be made very large, so such an attempt is industrially unrealistic in point of such as productivity, and further, it is impossible that a water-soluble polymer which further exercises the aforementioned high performance also in the clay dispersibility is obtained by merely the above increase of the molecular weight. There can also be its reverse case.

### DISCLOSURE OF THE INVENTION

### OBJECT OF THE INVENTION

Thus, an object of the present invention is to provide: a water-soluble polymer which can exercise a high calcium-ion-binding ability and a high clay dispersibility, for example, even under the aforementioned circumstances where high-hardness water is used; and a process for producing such a water-soluble polymer with ease and good productivity; and further, uses of such a water-soluble polymer.

### SUMMARY OF THE INVENTION

The present inventors diligently studied to solve the above problems. In its process, the present inventors have considered that, for making such as very high detergency exercised in cases of the use for builders for such as detergent compositions even under circumstances where water having still higher hardness is used, it important to find a water-soluble polymer having both the calcium-ion-binding ability and the clay dispersibility on specific high levels as a builder even in high-hardness water. As a result, the present inventors have completed the present invention by finding out and confirming that, if the physical properties possessed by the above water-soluble polymer are high performances such as: (1) a calcium-ion-binding ability of not less than 470 mgCaCO₃/g and further a clay dispersibility of not less than 0.90 in a test liquid having a calcium concentration of 50 ppm in terms of calcium carbonate; or (2) a calcium-ion-binding ability of not less than 430 mgCaCO₃/g and further a clay dispersibility of not less than 0.70 in a test liquid having a calcium concentration of 100 ppm in terms of calcium carbonate, then such a water-soluble polymer is very useful, for example, as a water-soluble polymer for detergent compositions and can solve the above problems all at once.

In addition, the present inventors have completed the present invention by finding out and confirming that such a water-soluble polymer can be obtained with ease, so the above problems can be solved all at once, if, when a polymerization reaction of a monomer component, essentially including a monoethylenically unsaturated monocarboxylic acid (salt) monomer and/or a monoethylenically unsaturated dicarboxylic acid (salt) monomer, is carried out with at least two. polymerization initiators essentially including hydrogen peroxide and further including the other initiators, this polymerization reaction is carried out (i) at a specific temperature, or (ii) under conditions where: the molar ratio between the monoethylenically unsaturated monocarboxylic acid (salt) monomer (m) and the monoethylenically unsaturated dicarboxylic acid (salt) monomer (d) (d/m) satisfies a specific range; and the monoethylenically unsaturated dicarboxylic acid (salt) monomer initially charged satisfies a specific neutralization degree; and further, hydrogen peroxide and the other initiators, being the polymerization initiators, are used in a specific weight ratio, or the addition of the other initiators is carried out at a specific addition rate; or (iii) under conditions where: the molar ratio between the monoethylenically unsaturated monocarboxylic acid (salt) monomer (m) and the monoethylenically unsaturated dicarboxylic acid (salt) monomer (d) (d/m) in the monomer components satisfies a specific range; and the monoethylenically unsaturated dicarboxylic acid (salt) monomer initially charged satisfies a specific neutralization degree; and further, hydrogen peroxide and the other initiators, being the polymerization initiators, are used in a specific weight ratio.

That is to say, a water-soluble polymer according to the present invention has a calcium-ion-binding ability of not less than 470 mgCaCO₃/g and further has a clay dispersibility of not less than 0.90 in a test liquid having a calcium concentration of 50 ppm in terms of calcium carbonate.

Another water-soluble polymer according to the present invention has a calcium-ion-binding ability of not less than 430 mgCaCO₃/g and further has a clay dispersibility of not less than 0:70 in a test liquid having a calcium concentration of 100 ppm in terms of calcium carbonate.

As to the above water-soluble polymer according to the present invention:

it is possible to have a weight-average molecular weight of 50,000-8,000;

it is possible to be a water-soluble polycarboxylic polymer containing, as an essential structural unit or essential structural units, a structural unit (M derived from a monoethylenically unsaturated monocarboxylic acid (salt) monomer and/or a structural unit (D) derived from a monoethylenically unsaturated dicarboxylic acid (salt) monomer;

it is possible to have both the structural units (M) and (D), wherein the total content of these two structural units is not lower than 90 weight %, and wherein the mutual molar ratio between them (D/M) is in the range of 35/65 to 65/35; and

more favorably, it is possible that the molar ratio (D/M) is in the range of 40/60 to 60/40.

Processes according to the present invention for production of a water-soluble polymer are processes comprising the step of polymerizing a monomer component to thereby obtain the water-soluble polymer, wherein the monomer component essentially includes a monoethylenically unsaturated monocarboxylic acid (salt) monomer (m) and/or a monoethylenically unsaturated dicarboxylic acid (salt) monomer (d). Of these processes,

the first process is characterized in that:

the polymerization is carried out with at least two polymerization initiators essentially including hydrogen peroxide, and the reaction temperature in this polymerization is set in the range of 99-80° C.;

the second process is characterized in that:

the molar ratio between the monomers (m) and (d) (d/m) is in the range of 35/65 to 65/35;

the polymerization is carried out with at least two polymerization initiators essentially including hydrogen peroxide, and the monomer (d) charged before addition of the polymerization initiators has a neutralization degree of 70 to 95 mol %; and

the weight ratio between hydrogen peroxide and the other initiators (hydrogen peroxide/other initiators) in the polymerization initiators in the polymerization is set at not less than 1.80, and/or the rate of the other initiators being added is set at not more than 1.40 g/mol·h; and

the third process is characterized in that:

the molar ratio between the monomers (m) and (d) (d/m) is in the range of 35/65 to 65/35;

the polymerization is carried out with at least two polymerization initiators essentially including hydrogen peroxide, and the monomer (d) charged before addition of the polymerization initiators has a neutralization degree of not less than 90 mol %; and

the weight ratio between hydrogen peroxide and the other initiators (hydrogen peroxide/other initiators) in the polymerization initiators in the polymerization is set in the range of 0.4 to 1.1.

A detergent composition according to the present invention comprises, as an essential component, the above water-soluble polymer according to the present invention.

A dispersant according to the present invention comprises, as an essential component, the above water-soluble polymer according to the present invention.

A water-treating agent according to the present invention comprises, as an essential component, the above water-soluble polymer according to the present invention.

### EFFECTS OF THE INVENTION

The present invention can provide: a water-soluble polymer which can exercise a high calcium-ion-binding ability and a high clay dispersibility even under circumstances where high-hardness water is used; and a process for producing such a water-soluble polymer with ease and good productivity; and further, uses of such a water-soluble polymer.

### DETAILED DESCRIPTION OF THE INVENTION

Hereinafter, detailed descriptions are given about the water-soluble polymer and its production process and uses according to the present invention. However, the scope of the present invention is not bound to these descriptions. And other than the following illustrations can also be carried out in the form of appropriate modifications of the following illustrations within the scope not departing from the spirit of the present invention.

The water-soluble polymer according to the present invention is characterized by having: (1) a calcium-ion-binding ability of not less than 470 mgCaCO₃/g and further a clay dispersibility of not less than 0.90 in a test liquid having a calcium concentration of 50 ppm in terms of calcium carbonate; or (2) a calcium-ion-binding ability of not less than 430 mgCaCO₃/g and further a clay dispersibility of not less than 0.70 in a test liquid having a calcium concentration of 100 ppm in terms of calcium carbonate; and can efficiently exercise the above excellent performances even in the case where high-hardness water is used.

Hereinafter, the water-soluble polymer of (1) above may be referred to as first water-soluble polymer, and the water-soluble polymer of (2) above may be referred to as second water-soluble polymer. In addition, the case of referring simply as water-soluble polymer means both the first water-soluble polymer and the second water-soluble polymer.

The calcium-ion-binding ability (mgCaCO₃/g) is defined as the milligrams of calcium ion (in terms of amount of calcium carbonate) being bound to 1 g of the water-soluble polymer, and is an index of how much calcium ion in water is bound to the water-soluble polymer. If the surfactant, which is used as a main component in uses for such as detergent compositions, bonds to calcium ion in water, then this surfactant becomes insoluble, so that its surface-activating effect greatly deteriorates. Hereupon, if the water-soluble polymer having a high calcium-ion-binding ability is used jointly with the surfactant, then the surfactant is prevented from becoming insoluble, so that the effects such as of enhancing the detergency are great and are sufficiently exercised. Though the value of the calcium-ion-binding ability depends on the measurement conditions, yet, because the water-soluble polymer according to the present invention has a high calcium-ion-binding ability, the value of the calcium-ion-binding ability as referred to in the present invention is defined as a value measured by a method and under conditions wherein these method and conditions are described in the below-mentioned detailed description of the preferred embodiments.

As to the first water-soluble polymer, it is important that its calcium-ion-binding ability is, as aforementioned, not less than 470 mgCaCO₃/g. However, it is favorably not less than 475 mgCaCO₃/g, more favorably not less than 480 mgCaCO₃/g. As the above calcium-ion-binding ability becomes higher, the abilities (as such as detergent builders) of the water-soluble polymer are favorably enhanced. In the case where the above calcium-ion-binding ability is less than 470 mgCaCO₃/g, there is a possibility that the effect of enhancing the detergency may be small.

As to the second water-soluble polymer, it is important that its calcium-ion-binding ability is, as aforementioned, not less than 430 mgCaCO₃/g. However, it is favorably not less than 450 mgCaCO₃/g, more favorably not less than 470 mgCaCO₃/g, still more favorably not less than 475 mgCaCO₃/g, particularly favorably not less than 480 mgCaCO₃/g. As the above calcium-ion-binding ability becomes higher, the abilities (as such as detergent builders) of the water-soluble polymer are favorably enhanced. In the case where the above calcium-ion-binding ability is less than 430 mgCaCO₃/g, there is a possibility that the effect of enhancing the detergency may be small.

The clay dispersibility is an index for seeing an effect of, during the washing, detaching such as mud dirt and then uniformly dispersing it to prevent clay from precipitating. Specifically, the clay dispersibility is usable as an index for seeing the effect of the redeposition-inhibiting function upon white cloth. The value of the clay dispersibility as referred to in the present invention is defined as a value measured by a method and under conditions wherein these method and conditions are described in the below-mentioned detailed description of the preferred embodiments. In detail, there are: a value of the clay dispersibility in a test liquid having a calcium concentration of 50 ppm in terms of calcium carbonate (hereinafter referred to as “clay dispersibility under a hardness of 50 ppm”); and a value of the clay dispersibility in a test liquid having a calcium concentration of 100 ppm in terms of calcium carbonate (hereinafter referred to as “clay dispersibility under a hardness of 100 ppm”).

As to the first water-soluble polymer, it is important that its clay dispersibility under a hardness of 50 ppm is, as aforementioned, not less than 0.90. However, it is favorably not less than 1.0, more favorably not less than 1.1. As the above clay dispersibility becomes higher, the abilities (as such as builders for detergents) are favorably enhanced. In the case where the above clay dispersibility is less than 0.90, there is a possibility that the effect of inhibiting the redeposition caused by mud dirt may be small.

As to the second water-soluble polymer, it is important that its clay dispersibility under a hardness of 100 ppm is not less than 0.70. However, it is more favorably not less than 0.80, still more favorably not less than 0.90. As the above clay dispersibility becomes higher, the abilities (as such as builders for detergents) are favorably enhanced. In the case where the above clay dispersibility is less than 0.70, there is a possibility that the effect of inhibiting the redeposition caused by mud dirt may be small.

As to the water-soluble polymer according to the present invention, although not limited, its weight-average molecular weight Mw is favorably in the range of 50,000-8,000, more favorably 45,000-9,000, still more favorably 40,000-10,000, particularly favorably 39,000-12,000. If the weight-average molecular weight Mw is in the above range, then there can be obtained an excellent effect such that the calcium-ion-binding ability and the clay dispersibility can be combined on high levels. In addition, in the case where the weight-average molecular weight Mw is more than 50,000, there is a possibility that: a variety of clay dispersibilities may be low, and besides, the rate of dissolution into water may be slow, thus resulting in failure to obtain sufficient effects. In addition, in the case where the weight-average molecular weight Mw is less than 8,000, there is a possibility that the calcium-ion-binding ability may be low.

The composition (namely, composition of structural units derived from monomers) of the water-soluble polymer according to the present invention is not limited. It is favorable to essentially contain a structural unit (M) derived from a monoethylenically unsaturated monocarboxylic acid (salt) monomer and/or a structural unit (D) derived from a monoethylenically unsaturated dicarboxylic acid (salt) monomer. The water-soluble polymer according to the present invention is favorably a water-soluble polycarboxylic polymer having such a structural unit or structural units. If the water-soluble polymer according to the present invention is such a water-soluble polycarboxylic polymer, then there can be obtained excellent effects such as of exercising the ability to disperse such as clay, in addition to having the ability to chelate such as calcium ion.

The monoethylenically unsaturated monocarboxylic acid (salt) monomer, from which the structural unit (M) is derived, may be either one of a monoethylenically unsaturated monocarboxylic acid and its salt, or may be their mixture, thus there being no limitation.

Although not limited, favorable examples of the monoethylenically unsaturated monocarboxylic acid include acrylic acid, methacrylic acid, α-hydroxyacrylic acid, and crotonic acid. Above all, acrylic acid and methacrylic acid are more favorable. These may be used either alone respectively or in combinations with each other, thus there being no limitation.

Examples of the monoethylenically unsaturated monocarboxylic acid salt include alkaline metal salts (e.g. sodium salts and potassium salts), alkaline earth metal salts (e.g. calcium salts and magnesium salts), ammonium salts, and organic amine salts (e.g. monoethanolamine salts and triethanolamine salts) of the above-enumerated monoethylenically unsaturated monocarboxylic acids. Above all, the alkaline metal salts (e.g. sodium salts and potassium salts) are favorable, and the sodium salts are more favorable. These may be used either alone respectively or in combinations with each other, thus there being no limitation. Incidentally, herein, the “salt” is permitted to be any of an acid type, a partial salt type, a perfect salt type, and their mixtures.

The monoethylenically unsaturated dicarboxylic acid (salt) monomer, from which the structural unit (D) is derived, may be either one of a monoethylenically unsaturated dicarboxylic acid and its salt, or may be their mixture, thus there being no limitation.

Although not limited, favorable examples of the monoethylenically unsaturated dicarboxylic acid include maleic acid, fumaric acid, itaconic acid, citraconic acid, and/or anhydrides of these acids. Above all, maleic acid, maleic anhydride, and fumaric acid are more favorable. These may be used either alone respectively or in combinations with each other, thus there being no limitation.

Examples of the monoethylenically unsaturated dicarboxylic acid salt include alkaline metal salts (e.g. sodium salts and potassium salts), alkaline earth metal salts (e.g. calcium salts and magnesium salts), ammonium salts, and organic amine salts (e.g. monoethanolamine salts and triethanolamine salts) of the above-enumerated monoethylenically unsaturated dicarboxylic acids. Above all, the alkaline metal salts (e.g. sodium salts and potassium salts) are favorable, and the sodium salts are more favorable. These may be used either alone respectively or in combinations with each other, thus there being no limitation.

As to the structural units (M) and (D) which can constitute the water-soluble polymer according to the present invention, only either one of them may be contained, or both may be contained, thus there being no limitation. However, a water-soluble polymer which contains both structural units (M) and (D) is favorable in that the calcium-ion-binding ability can be enhanced. In addition, the water-soluble polymer according to the present invention is favorably a water-soluble polymer which contains the structural units (M) and/or (D) in an amount of not smaller than 90 weight %, more favorably not smaller than 95 weight %, still more favorably not smaller than 98 weight %, in its molecular structure. If the above content is satisfied, then there can be obtained excellent effects such that it becomes possible to easily obtain a water-soluble polymer having a high calcium-ion-binding ability.

Above all, favorably, the water-soluble polymer according to the present invention has both the structural units (M and (D), wherein the total content of the structural units (M) and (D) is not lower than 90 weight %, and wherein the molar ratio between the structural units (M) and (D) (D/M) is in the range of 35/65 to 65/35. If the above total content and the above molar ratio are satisfied, then there can be obtained excellent effects such that it becomes possible to obtain a water-soluble polymer which is high both in the calcium-ion-binding ability and the clay dispersibility. In particular, the above total content is more favorably not lower than 95 weight %, still more favorably not lower than 98 weight %. In addition, the above molar ratio (D/M) is more favorably in the range of 35/65 to 60/40, still more favorably 38/62 to 55/45, particularly favorably 40/60 to 50/50, most favorably 43/57 to 47/53. In the case where the above total content is lower than 90 weight %, there is a possibility that the calcium-ion-binding ability may be low. In the case where the above molar ratio (D/M) is less than 35/65, there is a possibility that it may be difficult to obtain the water-soluble polymer having a high calcium-ion-binding ability. In the case where the above molar ratio (D/M) is more than 65/35, there is a possibility that the polymerizability may be poor, and further that a variety of clay dispersibilities of the resultant water-soluble polymer may be low. Incidentally, as to the molar ratio between the structural units (M) and (D) (D/M), if the monoethylenically unsaturated monocarboxylic acid (salt) monomer and the monoethylenically unsaturated dicarboxylic acid (salt) monomer remain unreacted in a small amount of not larger than 3 weight % relative to the solid components, then the above molar ratio (D/M) can be said to be the same as the molar ratio between the monoethylenically unsaturated monocarboxylic acid (salt) monomer and the monoethylenically unsaturated dicarboxylic acid (salt) monomer which have been used as the monomer components during the production of the water-soluble polymer.

The water-soluble polymer according to the present invention may contain another structural unit, derived from another monomer which is copolymerizable, besides the structural units (M) and (D). In such a case where the water-soluble polymer further contains the above structural unit derived from another monomer, the range of the content of this structural unit is favorably the range conditional on satisfying the aforementioned range of the total content of the structural units (M) and/or (D).

Although not limited, examples of the above other monomer which is copolymerizable include water-soluble monoethylenically unsaturated monomers, such as sulfonic-acid(-salt)-group-containing monoethylenically unsaturated monomer( salt)s and hydroxyl-group-containing monoethylenically unsaturated monomers. Above all, if the sulfonic acid group is introduced into the water-soluble polymer according to the present invention by use of the sulfonic-acid(-salt)-group-containing monoethylenically unsaturated monomer (salt), then the clay dispersibility in high-hardness water is very greatly enhanced as the case may be.

Examples of the sulfonic-acid(-salt)-group-containing monoethylenically unsaturated monomer (salt) include sulfonic-acid-group-containing unsaturated monomers and their salts (e.g. vinylsulfonic acid (salts), allylsulfonic acid (salts), methallylsulfonic acid (salts), sulfoethyl acrylate, sulfoethyl methacrylate, sulfopropyl acrylate, sulfopropyl methacrylate, 3-allyloxy-2-hydroxypropanesulfonic acid (salts), styrenesulfonic acid (salts), 2-acrylamido-2-methylpropanesulfonic acid (salts), 2-hydroxy-3-butenesulfonic acid (salts), 2-hydroxysulfopropyl (meth)acrylate, and sulfoethylmaleimide). These may be used either alone respectively or in combinations with each other. Favorable examples include 3-allyloxy-2-hydroxypropanesulfonic acid (salts), sulfoethyl acrylate, sulfoethyl methacrylate, and 2-hydroxy-3-butenesulfonic acid (salts).

Examples of the hydroxyl-group-containing monoethylenically unsaturated monomer include: 3-methyl-3-buten-1-ol (isoprenol), 3-methyl-2-buten-1-ol (prenol), and 2-methyl-3-buten-2-ol (isoprene alcohol), and hydroxyl-group-containing unsaturated monomers such as monomers obtained by addition reactions of 1 to 100 mols of ethylene oxide and/or propylene oxide to 1 mol of the above monomers (e.g. polyethylene glycol monoisoprenol ether, polypropylene glycol monoisoprenol ether); and 2-hydroxyethyl (meth)acrylate, polyethylene glycol mono(meth)acrylate, polypropylene glycol mono(meth)acrylate, polyethylene glycol monoallyl ether, polypropylene glycol monoallyl ether, glycerol monoallyl ether, α-hydroxyacrylic acid, N-methylol(meth)acrylamide, glycerol mono(meth)acrylate, vinyl alcohol, and α-hydroxyalkyl acrylates.

The aforementioned water-soluble monoethylenically unsaturated monomers can be exemplified by, besides the above-enumerated ones, others of which the examples include: vinyl acetate; (meth)allyl-etheric unsaturated monomers such as glycerol monoallyl ether and monomers obtained by addition reactions of 1 to 100 mols of ethylene oxide and/or propylene oxide to 1 mol of this monomer; end-alkyl-group-containing esteric unsaturated monomers, such as monoesters, their salts, and diesters wherein these monoesters and diesters are obtained from alcohols and unsaturated monocarboxylic monomers (e.g. (meth)acrylic acid and crotonic acid) or unsaturated polycarboxylic monomers (e.g. maleic acid, fumaric acid, itaconic acid, citraconic acid, and aconitic acid) wherein the above alcohols are obtained by addition reactions of.0 to 100 mols of ethylene oxide and/or propylene oxide to 1 mol of alkyl alcohols having 1 to 20 carbon atoms; and esteric unsaturated monomers, such as monoesteric monomers or monoesters, salts of these monoesters, and diesteric monomers, wherein the above monoesteric monomers are obtained by addition reactions of 1 to 100 mols of ethylene oxide and/or propylene oxide to 1 mol of unsaturated monocarboxylic monomers (e.g. (meth)acrylic acid and crotonic acid), and wherein the above monoesters and diesteric monomers are obtained by addition reactions of 1 to 100 mols of ethylene oxide and/or propylene oxide to 1 mol of unsaturated polycarboxylic monomers (e.g. maleic acid, fumaric acid, itaconic acid, citraconic acid, and aconitic acid).

The process for production of the aforementioned water-soluble polymer according to the present invention is not limited. Hitherto publicly known arts in the field of the production of water-soluble polymers are appropriately adoptable. Above all, the first, second, and third processes, which are aforementioned as the processes according to the present invention for production of a water-soluble polymer (hereinafter these processes may be referred to as production processes according to the present invention), are favorably applicable and, by these processes, the water-soluble polymer according to the present invention can be obtained with ease and good productivity.

Hereinafter, descriptions are given about a general process for production of a water-soluble polymer on occasions when the production processes according to the present invention are carried out. In addition, descriptions are given individually in detail about the features (important essential conditions) of the first, second, and third processes.

In the production processes according to the present invention, the monomer component being used is not limited. However, for example, it is favorable to essentially use a monoethylenically unsaturated monocarboxylic acid (salt) monomer (m) and/or a monoethylenically unsaturated dicarboxylic acid (salt) monomer (d). To the exemplification of these monomers, there can be applied the aforementioned descriptions about the water-soluble polymer according to the present invention. Incidentally, hereinafter, the monoethylenically unsaturated monocarboxylic acid (salt) monomer may be referred to simply as “monomer (m)”, and the monoethylenically unsaturated dicarboxylic acid (salt) monomer may be referred to simply as “monomer (d)”.

In the production processes according to the present invention, although not limited, the total amount ratio of the monomers (m) and/or (d) being used relative to the entirety of the monomer components being used is favorably not smaller than 90 weight %, more favorably not smaller than 95 weight %, still more favorably not smaller than 98 weight %. In the case where the above total amount ratio being used is smaller than 90 weight %, there is a possibility that the calcium-ion-binding ability may be low, and that the detergency may be low.

In the production processes according to the present invention, the mixing ratio between the monomers (m) and (d) being used is not limited. However, the molar ratio between them (d/m) is favorably in the range of 35/65 to 65/35, more favorably 35/65 to 60/40, still more favorably 38/62 to 55/45, particularly favorably 40/60 to 50/50. Above all, as to the third process, it is important that the above range of the molar ratio (d/m) is satisfied. In the case where the above molar ratio (d/m) is less than 35/65, there is a possibility that it may be difficult to obtain the water-soluble polymer having a high calcium-ion-binding ability. In the case where the above molar ratio (d/m) is more than 65/35, there is a possibility that the polymerizability may be poor, and further that a variety of clay dispersibilities of the resultant water-soluble polymer may be low.

As to the monomer (m), favorably not less than 50 weight %, more favorably not less than 70 weight %, of its entirety being used, still more favorably the entirety, is supplied to a reactor by dropping after the start of the polymerization. In the case where the monomer (m) is charged in an amount of larger than 50 weight % before the reaction, there is a possibility that it may be much difficult to control the molecular weight and its distribution, because the monomer (m) has much higher polymerizability than the monomer (d). The period of the above dropping is favorably in the range of 30 to 300 minutes, more favorably 60 to 180 minutes, since the start of the reaction. If the dropping is carried out within the above range of the period of the dropping, then there are advantages in that: the resultant water-soluble polymer has a narrow molecular weight distribution, so that the calcium-ion-binding ability and the clay dispersibility are enhanced. Also for enhancing the productivity, it may be favorable to end the dropping in a short time. However, in the case where the dropping is ended in less than 30 minutes, there is a possibility that the amount of the monomer (d), remaining after the end of the polymerization, may increase, or that such a large quantity of heat of reaction may be emitted in a short time as to involve difficulty in its removal. In addition, in the case where the dropping is ended in more than 300 minutes, there is a possibility that the productivity may be so much poor as to be disadvantageous in cost aspects.

As to the monomer (d), favorably not less than 50 weight %, more favorably not less than 70 weight %, of its entirety being used, still more favorably the entirety, is (initially) charged into the reactor before the reaction (before addition of polymerization initiators). In the case where the amount of the monomer (d) being (initially) charged before the reaction is smaller than 50 weight %, there is a possibility that the amount of the monomer (d), remaining after the end of the polymerization, may increase. In addition, the concentration of the monomer (d) at the start of the polymerization is favorably not less than 40 weight %, more favorably not less than 45 weight %, still more favorably not less than 50 weight %. In the case where the charging concentration is less than 40 weight %, there is a possibility that the amount of the monomer (d), remaining after the end of the polymerization, may increase.

In the production processes according to the present invention, the neutralization degree of the monomer (d) initially charged before addition of polymerization initiators is not limited. After this neutralization degree has appropriately been adjusted, the monomer (d) can be used. However, the monomer (d) in at least a part of its entirety being used (favorably, in an amount in the above range) is initially charged before addition of polymerization initiators, and further, and the neutralization degree of the monomer (d) initially charged in this way is, for example, favorably in the range of 70 to 95 mol %, more favorably 72 to 93 mol %, still more favorably 75 to 90 mol %. Above all, as to the second process, it is important that the above range of the neutralization degree is satisfied. In the case where the above neutralization degree is less than 70 mol %, there is a possibility that a variety of clay dispersibilities in the presence of calcium ion may be low due to block polymerization of the monomer (d). In the case where the above neutralization degree is more than 95 mol %, there is a possibility that the calcium-ion-binding ability and the detergency may be low due to the reduction of the efficiency of introducing the monomer (d).

In the production processes according to the present invention, furthermore, it is also possible to say that the above neutralization degree of the monomer (d) initially charged before addition of polymerization initiators is favorably not less than 90 mol %, more favorably in the range of 90 to 100 mol %. Above all, as to the third process, it is important that the above range of the neutralization degree is satisfied.

In the case where other monomers (e.g. the aforementioned water-soluble monoethylenically unsaturated monomers) are also used for the polymerization along with the monomers (m) and/or (d), then such as amounts of those other monomers being initially charged or dropped can be set appropriately with consideration sufficiently given to the amounts of the monomers (m) and/or (d) being used and to the polymerization reactivity of the above other monomers. As to the above other monomers, the period of their dropping can also appropriately be set. However, it is favorable to end it earlier than the dropping of the monomer (m).

In the production processes according to the present invention, although not limited, it is favorable to adopt stirring homogeneous polymerization in an aqueous solvent. When the above stirring homogeneous polymerization is carried out, hitherto publicly known arts and conditions are applicable. When the polymerization reaction is carried out, the aqueous solvent which is used as the reaction solvent is an aqueous solvent having a water content of favorably not lower than 80 weight %, more favorably 100 weight %. Examples of hydrophilic organic solvents usable as the aqueous solvent jointly with water include: lower alcohols such as methanol, ethanol, and isopropyl alcohol; amides such as diethylformamide; and ethers such as diethyl ether. These may be used either alone respectively or in combinations with each other.

In the production processes according to the present invention, the polymerization of the monomer component is carried out in the presence of polymerization initiators by adding the polymerization initiators to such as monomer component having been charged into the reactor. As the polymerization initiators, water-soluble polymerization initiators are used. Specifically, hydrogen peroxide is essentially used.

The addition (dropping supply) of the above hydrogen peroxide is ended not less than 20 minutes earlier than the end of the dropping of the monomer (m) favorably from the viewpoint of: simplification of production facilities; cost lowering; and the effect of decrease of hydrogen peroxide remaining at the end of the polymerization. The above production conditions can decrease the concentration of hydrogen peroxide, remaining at the end of the polymerization, to favorably not more than 2 weight %, more favorably not more than 1 weight %, still more favorably not more than 0.5 weight %, relative to the entirety of the reaction liquid. In addition, the above production conditions can decrease the amount of the monomer (d), remaining at the end of the polymerization, to favorably not more than 3 weight %, more favorably not more than 1 weight %, relative to the entirety of the reaction liquid. In the case where the amount of the residual monomer (d) is larger than 3 weight %, there is unfavorably a possibility of occurrence of problems such that crystals of the monomer (d) deposit themselves in cold districts in winter.

As to the production processes according to the present invention, it is important to use at least two polymerization initiators which essentially include the above hydrogen peroxide and further include other water-soluble polymerization initiators (other initiators). The above hydrogen peroxide and other initiators may be used at the same time, or at least a part of each may be used at a different time, thus there being no limitation.

Examples of the above other water-soluble polymerization initiators include: persulfates such as ammonium persulfate, sodium persulfate, and potassium persulfate; azo compounds such as 2,2′-azobis(2-amidinopropane) dihydrochloride, 4,4′-azobis(4-cyanovaleric acid), azobisisobutyronitrile, and 2,2′-azobis(4-methoxy-2,4-dimethylvaleronitrile); and organic peroxides such as benzoyl peroxide, lauroyl peroxide, peracetic acid, persuccinic acid, di-tert-butyl peroxide, tert-butyl hydroperoxide, and cumene hydroperoxide. These other water-soluble polymerization initiators may be used either alone respectively or in combinations with each other.

As to the addition of these other water-soluble polymerization initiators, it is favorable that their entireties are supplied to the reactor by dropping. The beginning and ending times of their dropping can appropriately be set. However, it is favorable to end their dropping after 10 to 20 minutes from the end of the dropping of the monomer (m). Thereby the amount of the residual monomer (m) can be reduced very much.

In the production processes according to the present invention, the reaction temperature in the polymerization of the above monomer component can appropriately be set without limitation. However, when the monomer component, essentially including the monomers (m) and/or (d), is polymerized, the reaction temperature in this polymerization is favorably set in the range of 99-80° C., more favorably 97-82° C., still more favorably 95-85° C. Above all, as to the first process, it is important that the above range of the reaction temperature is satisfied. If the polymerization of the monomer component is carried out under conditions satisfying the above range of the reaction temperature, then there can be obtained effects such that the water-soluble polymer according to the present invention can be obtained with ease and good productivity, and further that the foaming during the polymerization is prevented. On the other hand, in the case where the above reaction temperature is higher than 99° C., there is a possibility that the foaming may violently occur during the polymerization. In the case where the above reaction temperature is lower than 80° C., there is a possibility that the amount of hydrogen peroxide, remaining at the end of the polymerization, may increase.

In the production processes according to the present invention, the amount of hydrogen peroxide (among hydrogen peroxide and the other initiators, which are used as the polymerization initiators) being used can appropriately be set without limitation. However, this amount is, for example, favorably set at not larger than 4 g/mol, more favorably at not larger than 3.5 g/mol, still more favorably at not larger than 3 g/mol, in terms of weight relative to the total amount of the monomer component being used. If hydrogen peroxide is used in the above range of the amount being used, then there can be obtained effects such that the water-soluble polymer according to the present invention can be obtained with ease and good productivity. On the other hand, in the case where the amount of hydrogen peroxide being used is larger than 4 g/mol, there is a possibility that the foaming may violently occur during the polymerization.

In the production processes according to the present invention, the weight ratio between hydrogen peroxide and the other initiators (hydrogen peroxide/other initiators) which are used as the polymerization initiators, and the rate of the aforementioned other initiators (which are used as the polymerization initiators) being added, can appropriately be set without limitation.

Specifically, as to the above weight ratio, when the monomer component essentially including the monomers (m) and/or (d) is polymerized in the presence of the polymerization initiators, the weight ratio between hydrogen peroxide and the other initiators (hydrogen peroxide/other initiators) is, for example, favorably set at not less than 1.80, more favorably in the range of 1.85 to 4.50, still more favorably 1.90 to 4.00 (condition a). If the polymerization initiators satisfying the above range of the weight ratio are used, then there can be obtained effects such that the amount of the monomer (d), remaining at the end of the polymerization reaction, can be reduced, and that the water-soluble polymer according to the present invention can be obtained with ease and good productivity. On the other hand, in the case where the above weight ratio is less than 1.80, there is a possibility that the monomer (d) may remain in a large amount particularly on an occasion when the ratio of the monomer (d) in the monomer component is high. In the case where the above weight ratio is too large, there is a possibility that the foaming may violently occur during the polymerization.

As to the above weight ratio, furthermore, it is also possible to say that the weight ratio between hydrogen peroxide and the other initiators (hydrogen peroxide/other initiators) is favorably set in the range of 0.4 to 1.1, more favorably 0.5 to 1.0, still more favorably 0.6 to 0.9 (condition b). In the case where the above weight ratio is less than 0.4, there is a possibility that the monomer (d) may remain in a large amount. In the case where the above weight ratio is more than 1.1, there is a possibility that the foaming may much occur during the polymerization.

As to the above addition rate, the rate of the aforementioned initiators other than hydrogen peroxide (among the polymerization initiators being used), being added, is set favorably at not more than 1.40 g/mol·h, more favorably in the range of 1.38-0.20 g/mol·h, still more favorably 1.35-0.25 g/mol·h. If the aforementioned other initiators are added so as to satisfy the above range of the addition rate, then there can be obtained effects such that the calcium-ion-binding ability can be enhanced. On the other hand, in the case where the above addition rate is more than 1.40 g/mol·h, there is a possibility that the calcium-ion-binding ability may be low. In the case where the above addition rate is too small, there is a possibility that a variety of clay dispersibilities may be low.

Above all, as to the second process, it is important that: the above specific range (condition a) is satisfied with regard to the above weight ratio, and/or the above specific range is satisfied with regard to the above addition rate. In addition, as to the third process, it is important that: the above specific range (condition b) is satisfied with regard to the above weight ratio.

In the production processes according to the present invention, it is also possible to further use a polyvalent metal, if necessary, in order to enhance the efficiency of decomposing the polymerization initiators being used. Examples of usable effective polyvalent metal ions include iron ion, vanadium-atom-containing ion, and copper ion. Above all, as the polyvalent metal ions, Fe³⁺, Fe²⁺, Cu⁺, Cu²⁺, V²⁺, V³⁺, and VO²⁺ are favorable, and Fe³⁺, Cu²⁺, and VO²⁺ are more favorable. These polyvalent metal ions may be used either alone respectively or in combinations with each other. The concentration of the polyvalent metal ion is favorably in the range of 0.1 to 100 ppm relative to the entirety of the polymerization reaction liquid. In the case where the concentration of the polyvalent metal ion is lower than 0.1 ppm, there is a possibility that almost no effects of the polyvalent metal ion cannot be obtained. In the case where the concentration of the polyvalent metal ion being used is higher than 100 ppm, there is a possibility that the resultant water-soluble polymer may have such a large yellow index as to be unusable for uses such as detergent compositions.

The supply form of the polyvalent metal ion is not limited. Any metal compound and metal will do if they become ionized in the polymerization reaction system. Examples of such a metal compound and metal include: water-soluble metal salts (e.g. vanadium oxytrichloride, vanadium trichloride, vanadium oxalate, vanadium sulfate, anhydrous vanadic acid, ammonium metavanadate, ammonium sulfate hypovanadous [(NH₄)₂SO₄.VSO₄.6H₂O], ammonium sulfate vanadous [(NH₄)V(SO₄)₂.12H₂O], copper (II) acetate, copper (II) bromide, copper (II) acetylacetate, cupric chloride, ammonium copper chloride, copper carbonate, copper (II) chloride, copper (II) citrate, copper (II) formate, copper (II) hydroxide, copper nitrate, copper naphthenate, copper (II) oleate, copper maleate, copper phosphate, copper (II) sulfate, cuprous chloride, copper (I) cyanide, copper iodide, copper (I) oxide, copper thiocyanate, iron acetylacetonate, ammonium iron citrate, ammonium ferric oxalate, ammonium ferrous sulfate, ammonium ferric sulfate, iron citrate, iron fumarate, iron maleate, ferrous lactate, ferric nitrate, iron pentacarbonyl, ferric phosphate, ferric pyrophosphate); metal oxides (e.g. vanadium pentaoxide, copper (II) oxide, ferrous oxide, ferric oxide); metal sulfides (e.g. copper (II) sulfide, iron sulfide); and besides, copper powders and iron powders. It may be at any time as long as until the end of the reaction that such a metal compound and/or metal is charged into the reactor. However, favorably, the metal compound and/or metal is charged into the reactor before the start of the reaction.

In the production processes according to the present invention, the pH of the reaction liquid during the polymerization reaction can also appropriately be set. However,.for-enhancing the polymerizability of the monomer (d), it is favorable that the pH at the start of the polymerization is set in the range of 5 to 13, and it is more favorable to decrease the pH with the progress of the polymerization reaction. Examples of basic compounds for neutralization, which are used to adjust the pH during the polymerization reaction, include: hydroxides and carbonates of alkaline metals (e.g. sodium, potassium, lithium); ammonia; alkylamines (e.g. monomethylamine, diethylamine, trimethylamine, monoethylamine, dimethylamine, triethylamine); allcanolamines (e.g. monoethanolamine, diethanolamine, triethanolamine, isopropanolamine, sec-butanolamine); and pyridine. These may be used either alone respectively or in combinations with each other.

In the production processes according to the present invention, it is favorable to use the monomer component, the polymerization initiators, the aqueous solvent, and other various materials (being used if necessary) in such amounts that the theoretical solid component concentration will not be less than 40 weight % after the end of the polymerization. In the case where the theoretical solid component concentration is less than 40 weight %, there is a possibility that the resultant water-soluble polymer may have such a broad molecular weight distribution as to exercise bad influences on the calcium-ion-binding ability and the clay dispersibility.

In the production processes according to the present invention, other polymerization conditions, for example, the pressure during the polymerization reaction, are not limited. It is possible to appropriately select any pressure from among ordinary pressure (atmospheric pressure), increased pressure, and reduced pressure.

Hereinafter, descriptions are given about the uses of the water-soluble polymer according to the present invention.

The water-soluble polymer according to the present invention is usable for a wide range of various uses such as detergent compositions, dispersants, flocculants, scale inhibitors, chelating agents, water-treating agents, and fiber-treating agents. Above all, the uses for the detergent compositions, the dispersants, and the water-treating agents are favorable.

The detergent composition according to the present invention essentially comprises the water-soluble polymer according to the present invention and a surfactant. As to the detergent composition according to the present invention, it is favorable that: relative to the entirety of the detergent composition, the mixing ratio of the water-soluble polymer is in the range of 0.1 to 20 weight %, and the mixing ratio of the surfactant is in the range of 5 to 70 weight %. More favorably, relative to the entirety of the detergent composition, the mixing ratio of the water-soluble polymer is in the range of 0.5 to 15 weight %, and the mixing ratio of the surfactant is in the range of 20 to 60 weight %.

As the surfactant, there can be used any of anionic surfactants, nonionic surfactants, amphoteric surfactants, and cationic surfactants.

Examples of the anionic surfactants include alkylbenzenesulfonate salts, alkyl or alkenyl ether sulfate salts, alkyl or alkenyl sulfate salts, α-olefinsulfonate salts, α-sulfofatty acids or their ester salts, alkanesulfonate salts, saturated or unsaturated fatty acid salts, alkyl or alkenyl ether carboxylate salts, amino acid type surfactants, N-acylamino acid type surfactants, and alkyl or alkenyl phosphate esters or their salts.

Examples of the nonionic surfactants include polyoxyalkylene alkyl or alkenyl ethers, polyoxyethylene alkyl phenyl ethers, higher fatty acid alkanolamides or their alkylene oxide addition products, sucrose fatty acid esters, alkyl glycoxides, fatty acid glycerol monoesters, and alkylamine oxides.

Examples of the amphoteric surfactants include carboxy type or sulfobetaine type amphoteric surfactants. Examples of the cationic surfactants include quaternary ammonium salts.

The detergent composition including the water-soluble polymer according to the present invention may be mixed with an enzyme, if necessary. Examples of the enzyme being mixed include protease, lipase and cellulase. Particularly, protease, alkali lipase and alkali cellulase are favorable because these exhibit high activity in alkali washing liquids. The amount of the enzyme being mixed is favorably in the range of 0.01 to 5 weight % relative to the entirety of the detergent composition. In the case where it deviates from this range, the balance with the surfactant is broken, thus resulting in failure to enhance the detergency. If necessary, the detergent composition including the water-soluble polymer according to the present invention may further be mixed with publicly known components conventionally used for detergent compositions, such as alkaline builders, chelate builders, anti-redeposition agents, soil-release agents, dye transfer inhibitors, softening agents, fluorescent agents, bleaching agents, bleach activators and perfumes. In addition, zeolite may be added. Usable examples of the alkaline builders include silicate salts, carbonate salts and sulfate salts. Examples of the chelate builders, usable if necessary, include diglycolic acid, oxycarboxylate salts, EDTA (ethylenediaminetetraacetic acid), DTPA (diethylenetriaminepentaacetic acid) and citric acid. Or publicly known water-soluble polycarboxylic polymers may be used within the range not damaging the effects of the present invention.

Examples of the dispersant according to the present invention include inorganic-pigment dispersants. The dispersant according to the present invention may comprise only the water-soluble polymer according to the present invention, or may further comprise publicly known water-soluble polymers as other additives within the range not producing any influence upon performances or effects. For example, such as polymerized phosphoric acid and its salts, phosphonic acid and its salts, and poly(vinyl alcohol) may be used as the above other additives. In the case where the water-soluble polymer according to the present invention is used for the dispersant, the content of the water-soluble polymer according to the present invention relative to the dispersant is not limited. However, this content is favorably in the range of 5 to 100 weight %. In any case, the above dispersant exhibits good performance as a dispersant for inorganic pigments such as heavy or light calcium carbonate (as used for paper coating) and clay. If a small amount of dispersant comprising the water-soluble polymer according to the present invention is added to an inorganic pigment and then dispersed into water along with the pigment, then high-concentration inorganic pigment slurries such as high-concentration calcium carbonate slurries can be produced wherein the high-concentration inorganic pigment slurries have a low viscosity and a high fluidity, and further, a good stability of these properties in the passage of time. In the case where the above dispersant is used as the inorganic-pigment dispersant, the amount of this inorganic-pigment dispersant being used is favorably in the range of 0.05 to 2.0 weight parts per 100 weight parts of the inorganic pigment. In the case where the amount of the inorganic-pigment dispersant being used is smaller than 0.05 weight parts, a sufficient dispersing effect cannot be obtained. On the other hand, in the case where the amount of the inorganic-pigment dispersant being used is larger than 2.0 weight parts, there is unfavorably a possibility of disadvantages also in economical aspects because an effect rewarding the amount of the addition is not obtained any longer.

The water-treating agent according to the present invention may comprise only the water-soluble polymer according to the present invention, or may be in the form of a composition further comprising such as polymerized phosphate salts, phosphonate salts, anticorrosive agents, slime-controlling agents, and chelating agents. The water-treating agent may further comprise publicly known water-soluble polymers within the range not producing any influence upon performances or effects. In any case, this water-treating agent is useful for inhibiting the formation of scale in systems such as cooling water circulation systems, boiler water circulation systems, seawater desalination plants, pulp digesters, and black liquor evaporators.

The fiber-treating agent favorably comprises the water-soluble polymer according to the present invention and at least one member selected from the group consisting of dyeing agents, peroxides and surfactants. In the case where the water-soluble polymer according to the present invention is used for the fiber-treating agent, the content of the water-soluble polymer according to the present invention relative to the fiber-treating agent is not limited. This content is favorably in the range of 1 to 100 weight %, more favorably 5 to 100 weight %. The fiber-treating agent may further comprise publicly known water-soluble polymers within the range not producing any influence upon performances or effects. However, in view of the physical properties, a more favorable form of the fiber-treating agent is such that the polymer component in the fiber-treating agent comprises the water-soluble polymer according to the present invention. Hereinafter, examples of the mixing to give the fiber-treating agent involving the use of the water-soluble polymer according to the present invention are shown in the form still closer to modes for carrying out the present invention. This fiber-treating agent can be used in the steps, such as scouring, dyeing, bleaching, and soaping steps, in the treatment process for fibers. Examples of the dyeing agents, peroxides, and surfactants include those which are conventionally used for fiber-treating agents. The ratio between the water-soluble polymer according to the present invention and the above at least one member selected from the group consisting of dyeing agents, peroxides, and surfactants is, for example, for improvements of fibers with regard to the whiteness degree, the color evenness, and the degree of dyed colorfastness, such that 1 weight part of the water-soluble polymer according to the present invention is mixed with 0.1 to 100 weight parts of the at least one member selected from the group consisting of dyeing agents, peroxides, and surfactants. It is one of favorable modes of the fiber-treating agent for carrying out the present invention that the fiber-treating agent having such a mixing ratio is used in an aqueous solution state having a definite concentration. This definite concentration can be determined appropriately for the use form or purpose, thus there being no limitation. The fiber for which the fiber-treating agent can be used is not limited. However, examples thereof include: cellulose fibers such as cotton and hemp; chemical fibers such as nylon and polyester; animal fibers such as wool and silk; semisynthetic fibers such as rayon; and their fabrics and blends. In the case where the fiber-treating agent is applied to the scouring step, it is favorable that the water-soluble polymer according to the present invention is mixed with alkali agents and surfactants. In the case where the fiber-treating agent is applied to the bleaching step, it is favorable that the water-soluble polymer according to the present invention is mixed with peroxides and with silicic chemicals, which are used as decomposition inhibitors for alkaline bleaching agents, such as sodium silicate.

### DETAILED DESCRIPTION OF THE PREFERRED EMBODIMENTS

Hereinafter, the present invention is more specifically illustrated by the following Examples of some preferred embodiments in comparison with Comparative Examples not according to the present invention. However, the present invention is not limited to them in any way. Incidentally, hereinafter, for convenience, the unit “liter(s)” may be referred to simply as “L”. In addition, the unit “weight %” may be referred to as “wt %”.

The measurement methods in the Examples and the Comparative Examples are shown below.

<Weight-Average Molecular Weight (Mw)>:

This was measured by GPC (gel permeation chromatography) under the following conditions.

Column: GF-7MHQ (produced by SHOWA DENKO Corporation)

Column temperature: 35° C.

Eluent: an aqueous solution as prepared by a process including the steps of: adding pure water to 34.5 g of disodium hydrogenphosphate dodecahydrate and 46.2 g of sodium dihydrogenphosphate dihydrate (both of which were special grade reagents; the reagents as used for the following variety of measurement were all special-grade ones) to adjust the entirety to 5,000 g; and then filtering the resultant mixture through a membrane filter of 0.45 μm in filter pore diameter.

Detector: UV 214 nm (Model 481 produced by Nippon Waters Co., Ltd.)

Flow rate: 0.5 mL/min

Calibration curve: poly(sodium acrylate) standard samples (produced by Sowa Kagaku Co., Ltd.)

<Calcium-Ion-Binding Ability>:

(1a) First, standard aqueous calcium ion solutions (aqueous solutions for drawing a calibration curve) were prepared by a process including the steps of: preparing 50 mL each of aqueous solutions of 0.01 mol/L, 0.002 mol/L, 0.001 mol/L, and 0.0001 mol/L respectively in Ca²⁺ ion concentration from calcium chloride dihydrate; and then adjusting their respective pH to 10±0.5 with a 1 wt % aqueous sodium hydroxide solution; and then adding thereto 1 mL of a 4 mol/L aqueous potassium chloride solution.

(2a) Next, an aqueous solution of a sample to be measured was prepared by a process including the steps of: weighing out 10 mg (in terms of solid components) of an aqueous polymer solution into a 100 mL beaker; and then adding thereto 50 mL of a 0.002 mol/L aqueous calcium ion solution having been prepared from calcium chloride dihydrate; and then uniformly stirring the contents of the beaker with a stirrer; and then adjusting the pH to 10±0.5 with a 1 wt % aqueous sodium hydroxide solution; and then adding thereto 1 mL of a 4 mol/L aqueous potassium chloride solution.

(3a) The measurement was carried out by a calcium ion electrode 93-20 (produced by OLION Co.) with an ion analyzer EA920 (produced by OLION Co.).

(4a) The amount of calcium ion, having been bound to the sample (polymer), was determined from the calibration curve and the measured value of the sample. Then, the determined amount per 1 g of the solid components in the polymer was denoted by the milligrams in terms of calcium carbonate, and its value was taken as the calcium-ion-binding ability value (mgCaCO₃/g).

<Clay Dispersibility Under Hardness of 50 ppm>:

(1b) First, a glycine buffer solution was prepared by adding ion-exchanged water to 67.56 g of glycine, 52.6 g of sodium chloride, and 60 mL of 1N—NaOH to adjust the total weight to 600 g.

(2b) A dispersion was prepared by a process including the steps of: dissolving 0.0817 g of calcium chloride dihydrate into 60 g of the buffer solution of (1b) above; and then adding thereto ion-exchanged water to adjust the total weight to 1,000 g.

(3b) Next, an aqueous solution of the resultant water-soluble polymer (adjusted to pH 7) was prepared so as to be 0.1 wt % in concentration in terms of solid component content.

(4b) Next, 0.3 g of clay of JIS test powders 1, class 11 (Kanto loam, super fine particles: produced by The Association of Powder Process Industry & Engineering, Japan) was placed into a test tube, and then thereto there were added 27 g of the prepared liquid of (2b) above and 3 g of the prepared liquid of (3b) above. At this stage, the resultant test liquid had a calcium concentration of 50 ppm in terms of calcium carbonate.

(5b) The test tube was sealed with a parafilm and then shaken lightly so that the clay would be dispersed into the entirety of the test liquid. Thereafter, the test tube was further shaken up and down 20 times.

(6b) The test tube was then allowed to stand stationary for 20 hours in a place 5 as not exposed to direct sunlight. Thereafter, 5 mL of supernatant of the dispersion was sampled with a whole pipette.

(7b) The absorbance (ABS) of the sampled liquid was measured in a cell of 1 cm under conditions of wavelength=380 nm with a UV spectroscope, and the resultant value was taken as the clay dispersibility under the hardness of 50 ppm.

<Clay Dispersibility Under Hardness of 100 ppm>:

(1c) First, a glycine buffer solution was prepared by adding ion-exchanged water to 67.56 g of glycine, 52.6 g of sodium chloride, and 60 mL of 1N—NaOH to adjust the total weight to 600 g.

(2c) A dispersion was prepared by a process including the steps of: dissolving 0.1634g of calcium chloride dihydrate into 60 g of the buffer solution of (1c) above; and then adding thereto ion-exchanged water to adjust the total weight to 1,000 g.

(3c) Next, an aqueous solution of the resultant water-soluble polymer (adjusted to pH 7) was prepared so as to be 0.1 wt % in concentration in terms of solid component content.

(4c) Next, 0.3 g of clay of JIS test powders 1, class 11 (Kanto loam, super fine particles: produced by The Association of Powder Process Industry & Engineering, Japan) was placed into a test tube, and then thereto there were added 27 g of the prepared liquid of (2c) above and 3 g of the prepared liquid of (3c) above. At this stage, the resultant test liquid had a calcium concentration of 100 ppm in terms of calcium carbonate.

(5c) The test tube was sealed with a parafilm and then shaken lightly so that the clay would be dispersed into the entirety of the test liquid. Thereafter, the test tube was further shaken up and down 20 times.

(6c) The test tube was then allowed to stand stationary for 20 hours in a place as not exposed to direct sunlight. Thereafter, 5 mL of supernatant of the dispersion was sampled with a whole pipette.

(7c) The absorbance (ABS) of the sampled liquid was measured in a cell of 1 cm under conditions of wavelength=380 nm with a UV spectroscope, and the resultant value was taken as the clay dispersibility under the hardness of 100 ppm.

<Detergency>:

(1d) Cotton-knitted cloth, having been obtained from Test Fabric, was cut into pieces of 10×10 cm to prepare white cloth. In addition, cotton cloth (STC GC C), having been obtained from Scientific Service, was cut into pieces of 4.5×7 cm to prepare artificially soiled fabrics. The whiteness degrees of these white cloth and artificially soiled fabrics were beforehand measured by the reflectance with a calorimetric color difference meter SE2000 produced by Nippon Denshoku Kogyo Co., Ltd.

(2d) Hard water was prepared by adding pure water to 1.47 g of calcium chloride dihydrate to adjust the total weight to 10 kg.

(3d) An aqueous surfactant solution was prepared by adding pure water to 12.5 g of sodium dodecylbenzenesulfonate (LAS), 12.5 g of sodium polyoxyethylene lauryl ether sulfate (AES), and 25 g of sodium carbonate to adjust the total weight to 1,000 g.

(4d) A Terg-O-Tometer was set to 25° C. Then, 500 mL of the above hard water, 0.20 g of zeolite, 5 mL of the aqueous polymer solution (solid component content: 0.5 wt %), 4.8 mL of the aqueous surfactant solution (having been prepared in (3d) above), 5 pieces of the artificially soiled fabrics, and 5 pieces of the white cloth were placed into a pot of the Terg-O-Tometer and then stirred at 100 rpm for 30 minutes.

(5d) The artificially soiled fabrics and the white cloth were got out of the pot and then drained of water by hand. Then, 500 mL of the above hard water was placed into the pot, and then thereto the artificially soiled fabrics and the white cloth, having been drained of water, were added. Thereafter, the contents of the pot were stirred at 100 rpm for 2 minutes.

(6d) The white cloth and the artificially soiled fabrics were got out of the pot, and then drained of water by hand, and then dried while their wrinkles were ironed out with each of the white cloth and the artificially soiled fabrics covered by other cloth. Thereafter, the whiteness degrees of the dried white cloth and of the dried artificially soiled fabrics were measured by the reflectance with the above calorimetric color difference meter.

(7d) The detergency (%) was determined from the measured values (having been obtained in the above way) in accordance with the following equation:
Detergency (%)=(whiteness degree of artificially soiled fabrics after washing−whiteness degree of artificially soiled fabrics before washing)÷(whiteness degree of white cloth before washing−whiteness degree of artificially soiled fabrics before washing}×100

### EXAMPLE 1

An amount of 78.0 g of ion-exchanged water (hereinafter referred to as pure water), 283.3 g of 48 wt % aqueous sodium hydroxide solution (hereinafter referred to as 48% NaOH), and 196.0 g of maleic anhydride (hereinafter referred to as anhydrous MA) were initially charged into a SUS-made separable flask of 2.5 L in capacity as fitted with a thermometer, a stirrer, and a reflux condenser. The resultant aqueous solution was heated until coming into a boiling point reflux state while being stirred. Incidentally, the neutralization degree of the MA in the initially charged aqueous solution was 85 mol %.

Next, while the reflux state was maintained under stirred conditions, the following materials were dropped from their respective separate dropping nozzles: 180.0 g of 80 wt % aqueous acrylic acid solution (hereinafter referred to as 80% AA); 11.4 g of 35 wt % aqueous hydrogen peroxide solution (hereinafter referred to as 35% H₂O₂); 32.0 g of 15 wt % aqueous sodium persulfate solution (hereinafter referred to as 15% NaPS); and 200.0 g of pure water. Incidentally, the amounts of the above hydrogen peroxide and sodium persulfate, being used as the polymerization initiators, were 1.0 g/mol and 1.2 g/mol respectively, and the weight ratio therebetween (hereinafter referred to simply as “H₂O₂/NaPS”) was 0.83, and the molar ratio between the amounts of the above acrylic acid and maleic acid being used (maleic acid/acrylic acid) (hereafter referred to simply as “MA/AA”) was 50/50.

As to the 80% AA and the 35% H₂O₂, their respective entireties were dropped continuously over a period of 120 minutes since the start of the polymerization. As to the 15% NAPS and the pure water, their respective entireties were dropped continuously over a period of 150 minutes since the start of the polymerization. In this period, the rate of the dropping (rate of addition) of the 15% NAPS was 0.48 g/mol·h.

Furthermore, the boiling point reflux state was maintained over a period of 30 minutes since the end of all the above droppings, thus completing the polymerization.

After the completion of the polymerization, the pH and the concentration were adjusted to obtain a water-soluble polymer (1) having a pH of 7.5 and a solid component concentration of 40 wt %.

The water-soluble polymer (1) had a calcium-ion-binding ability of 454 mgCaCO₃/g, a clay dispersibility of 1.13 under the hardness of 50 ppm, a clay dispersibility of 0.95 under the hardness of 100 ppm, and a weight-average molecular weight of 27,300.

The conditions and results of Example 1 are collectively shown in Table 1.

### EXAMPLE 2

An amount of 70.6 g of pure water, 255.0 g of 48% NaOH, and 176.4 g of anhydrous MA were initially charged into the same flask as of Example 1. The resultant aqueous solution was heated until coming into a boiling point reflux state while being stirred. Incidentally, the neutralization degree of the MA in the initially charged aqueous solution was 85 mol %.

Next, while the reflux state was maintained under stirred conditions, the following materials were dropped from their respective separate dropping nozzles: 198.0 g of 80% AA; 45.7 g of 35% H₂O₂; 80.0 g of 15% NaPS; and 131.8 g of pure water. Incidentally, the amounts of the above H₂O₂ and NaPS being used were 4.0 g/mol and 3.0 g/mol respectively, and the H₂O₂/NaPS was 1.33, and the MA/AA was 45/55.

As to the 80% AA, its entirety was dropped continuously over a period of 120 minutes since the start of the polymerization. As to the 35% H₂O₂ and the pure water, their respective entireties were dropped continuously over a period of 50 minutes since the start of the polymerization. As to the 15% NAPS, its entirety was dropped continuously over a period of 130 minutes since the start of the polymerization. In this period, the rate of the dropping (rate of addition) of the 15% NaPS was 1.38 g/mol·h.

Furthermore, the boiling point reflux state was maintained over a period of 20 minutes since the end of all the above droppings, thus completing the polymerization.

After the completion of the polymerization, the pH and the concentration were adjusted to obtain a water-soluble polymer (2) having a pH of 7.5 and a solid component concentration of 45 wt %.

The water-soluble polymer (2) had a calcium-ion-binding ability of 436 mgCaCO₃/g, a clay dispersibility of 0.93 under the hardness of 50 ppm, a clay dispersibility of 1.20 under the hardness of 100 ppm, and a weight-average molecular weight of 12,300.

The conditions and results of Example 2 are collectively shown in Table 1.

### EXAMPLE 3

An amount of 70.6 g of pure water, 255.0 g of 48% NaOH, and 176.4 g of anhydrous MA were initially charged into the same flask as of Example 1. The resultant aqueous solution was heated until coming into a boiling point reflux state while being stirred. Incidentally, the neutralization degree of the MA in the initially charged aqueous solution was 85 mol %.

Next, while the reflux state was maintained under stirred conditions, the following materials were dropped from their respective separate dropping nozzles: 198.0 g of 80% AA; 22.9 g of 35% H₂O₂; 53.3 g of 15% NaPS; and 173.4 g of pure water. Incidentally, the amounts of the above H₂O₂ and NAPS being used were 2.0 g/mol and 2.0 g/mol respectively, and the H₂O₂/NaPS was 1.00, and the MA/AA was 45/55.

As to the 80% AA, its entirety was dropped continuously over a period of 120 minutes since the start of the polymerization. As to the 35% H₂O₂ and the pure water, their respective entireties were dropped continuously over a period of 50 minutes since the start of the polymerization. As to the 15% NaPS, its entirety was dropped continuously over a period of 130 minutes since the start of the polymerization. In this period, the rate of the dropping (rate of addition) of the 15% NAPS was 0.92 g/mol·h.

Furthermore, the boiling point reflux state was maintained over a period of 20 minutes since the end of all the above droppings, thus completing the polymerization.

After the completion of the polymerization, the pH and the concentration were adjusted to obtain a water-soluble polymer (3) having a pH of 7.5 and a solid component concentration of 45 wt %.

The water-soluble polymer (3) had a calcium-ion-binding ability of 452 mgCaCO₃/g, a clay dispersibility of 1.14 under the hardness of 50 ppm, a clay dispersibility of 0.82 under the hardness of 100 ppm, and a weight-average molecular weight of 17,000. In addition, the water-soluble polymer (3) had a detergency of 45%.

The conditions and results of Example 3 are collectively shown in Table 1.

### EXAMPLE 4

An amount of 78.0 g of pure water, 283.3 g of 48% NaOH, 196.0 g of anhydrous MA, and 0.008 g of Mohr's salt were initially charged into the same flask as of Example 1. The resultant aqueous solution was heated to 95° C. while being stirred. Incidentally, the neutralization degree of the MA in the initially charged aqueous solution was 85 mol %.

Next, while 95° C. was maintained under stirred conditions, the following materials were dropped from their respective separate dropping nozzles: 180.0 g of 80% AA; 44.0 g of 35% H₂O₂; 53.3 g of 15% NAPS; and 173.4 g of pure water. Incidentally, the amounts of the above H₂O₂ and NaPS being used were 3.85 g/mol and 2.0 g/mol respectively, and the H₂O₂/NaPS was 1.92, and the MA/AA was 50/50.

As to the 80% AA, its entirety was dropped continuously over a period of 120 minutes since the start of the polymerization. As to the 35% H₂O₂, its entirety was dropped continuously over a period of 50 minutes since the start of the polymerization. As to the 15% NaPS and the pure water, their respective entireties were dropped continuously over a 80-minute-long period of from 50 minutes till 130 minutes after the start of the polymerization. In this period, the rate of the dropping (rate of addition) of the 15% NAPS was 1.50 g/mol·h.

Furthermore, 95° C. was maintained over a period of 20 minutes since the end of all the above droppings, thus completing the polymerization.

After the completion of the polymerization, the pH and the concentration were adjusted to obtain a water-soluble polymer (4) having a pH of 7.5 and a solid component concentration of 45 wt %.

The water-soluble polymer (4) had a calcium-ion-binding ability of 450 mgCaCO₃/g, a clay dispersibility of 1.50 under the hardness of 50 ppm, a clay dispersibility of 0.33 under the hardness of 100 ppm, and a weight-average molecular weight of 13,400.

The conditions and results of Example 4 are collectively shown in Table 1.

### EXAMPLE 5

A water-soluble polymer (5) was obtained in the same way as of Example 4 except that the Mohr's salt was not used.

The water-soluble polymer (5) had a calcium-ion-binding ability of 450 mgCaCO₃/g, a clay dispersibility of 1.53 under the hardness of 50 ppm, a clay dispersibility of 0.28 under the hardness of 100 ppm, and a weight-average molecular weight of 15,900.

The conditions and results of Example 5 are collectively shown in Table 1.

### EXAMPLE 6

An amount of 61.0 g of pure water, 300.0 g of 48% NaOH, and 235.2 g of anhydrous MA were initially charged into the same flask as of Example 1. The resultant aqueous solution was heated until coming into a boiling point reflux state while being stirred. Incidentally, the neutralization degree of the MA in the initially charged aqueous solution was 75 mol %.

Next, while the reflux state was maintained under stirred conditions, the following materials were dropped from their respective separate dropping nozzles: 144.0 g of 80% AA; 68.6 g of 35% H₂O₂; 53.3 g of 15% NAPS; and 101.0 g of pure water. Incidentally, the amounts of the above hydrogen peroxide and sodium persulfate, being used as the polymerization initiators, were 6.0 g/mol and 2.0 g/mol respectively, and the H₂O₂/NaPS was 3.00, and the MA/AA was 60/40.

As to the 80% AA, its entirety was dropped continuously over a period of 120 minutes since the start of the polymerization. As to the 35% H₂O₂ and the pure water, their respective entireties were dropped continuously over a period of 50 minutes since the start of the polymerization. As to the 15% NaPS, its entirety was dropped continuously over a 80-minute-long period of from 50 minutes till 130 minutes after the start of the polymerization. In this period, the rate of the dropping (rate of addition) of the 15% NAPS was 1.50 g/mol·h.

Furthermore, the boiling point reflux state was maintained over a period of 20 minutes since the end of all the above droppings, thus completing the polymerization.

After the completion of the polymerization, the pH and the concentration were adjusted to obtain a water-soluble polymer (6) having a pH of 7.5 and a solid component concentration of 50 wt %.

The water-soluble polymer (6) had a calcium-ion-binding ability of 456 mgCaCO₃/g, a clay dispersibility of 1.22 under the hardness of 50 ppm, and a weight-average molecular weight of 9,300.

The conditions and results of Example 6 are collectively shown in Table 2.

### COMPARATIVE EXAMPLE 1

An amount of 132.8 g of pure water, 400.0 g of 48% NaOH, and 235.2 g of anhydrous MA were initially charged into the same flask as of Example 1. The resultant aqueous solution was heated until coming into a boiling point reflux state while being stirred. Incidentally, the neutralization degree of the MA in tile initially charged aqueous solution was 100 mol %.

Next, while the reflux state was maintained under stirred conditions, the following materials were dropped from their respective separate dropping nozzles: 216.0 g of 80% AA; 57.6 g of 35% H₂O₂; 96.0 g of 15%NaPS; and 160.0 g of pure water. Incidentally, the amounts of the above hydrogen peroxide and sodium persulfate, being used as the polymerization initiators, were 4.2 g/mol and 3 g/mol respectively, and the H₂O₂/NaPS was 1.40, and the MA/AA was 50/50.

As to the 80% AA, its entirety was dropped continuously over a period of 180 minutes since the start of the polymerization. As to the 35% H₂O₂, its entirety was dropped continuously over a period of 50 minutes since the start of the polymerization. As to the 15% NAPS and the pure water, their respective entireties were dropped continuously over a 100-minute-long period of from 90 minutes till 190 minutes after the start of the polymerization. In this period, the rate of the dropping (rate of addition) of the 15% NaPS was 1.80 g/mol·h.

Furthermore, the boiling point reflux state was maintained over a period of 30 minutes since the end of all the above droppings, thus completing the polymerization.

After the completion of the polymerization, the pH and the concentration were adjusted to obtain a comparative water-soluble polymer (A) having a pH of 7.5 and a solid component concentration of 45 wt %.

The comparative water-soluble polymer (A) had a calcium-ion-binding ability of 460 mgCaCO₃/g, a clay dispersibility of 1.25 under the hardness of 50 ppm, a clay dispersibility of 0.40 under the hardness of 100 ppm, and a weight-average molecular weight of 10,000. In addition, the comparative water-soluble polymer (A) had a detergency of 43%.

The conditions and results of Comparative Example 1 are collectively shown in Table 2.

### COMPARATIVE EXAMPLE 2

An amount of 83.0 g of pure water, 250.0 g of 48% NaOH, and 147.0 g of anhydrous MA were initially charged into the same flask as of Example 1. The resultant aqueous solution was heated until coming into a boiling point reflux state while being stirred. Incidentally, the neutralization degree of the MA in the initially charged aqueous solution was 100 mol %.

Next, while the reflux state was maintained under stirred conditions, the following materials were dropped from their respective separate dropping nozzles: 315.0 g of 80% AA; 66.7 g of 15% NaPS; and 393.3 g of pure water. Incidentally, the amount of the above sodium persulfate, being used as the polymerization initiator, was 2 g/mol, and the H₂O₂/NaPS was 0, and the MA/AA was 30/70.

As to the 80% AA, its entirety was dropped continuously over a period of 120 minutes since the start of the polymerization. As to the 15% NAPS and the pure water, their respective entireties were dropped continuously over a period of 130 minutes since the start of the polymerization. In this period, the rate of the dropping (rate of addition) of the 15% NAPS was 0.92 g/mol·h.

Furthermore, the boiling point reflux state was maintained over a period of 30 minutes since the end of all the above droppings, thus completing the polymerization.

After the completion of the polymerization, the pH and the concentration were adjusted to obtain a comparative water-soluble polymer (B) having a pH of 7.5 and a solid component concentration of 40 wt %.

The comparative water-soluble polymer (B) had a calcium-ion-binding ability of 468 mgCaCO₃/g, a clay dispersibility of 0.75 under the hardness of 50 ppm, a clay dispersibility of 0.57 under the hardness of 100 ppm, and a weight-average molecular weight of 50,000. In addition, the comparative water-soluble polymer (B) had a detergency of 39%.

The conditions and results of Comparative Example 2 are collectively shown in Table 2.

### EXAMPLE 7

An amount of 107.9 g of pure water, 325.0 g of 48% NaOH, and 191.1 g of anhydrous MA were initially charged into the same flask as of Example 1. The resultant aqueous solution was heated until coming into a boiling point reflux state while being stirred. Incidentally, the neutralization degree of the MA in the initially charged aqueous solution was 100 mol %.

Next, while the reflux state was maintained under stirred conditions, the following materials were dropped from their respective separate dropping nozzles: 274.5 g of 80% AA; 14.3 g of 35% H₂O₂; 66.7 g of 15% NaPS; and 200.0 g of pure water. Incidentally, the amounts of the above hydrogen peroxide and sodium persulfate, being used as the polymerization initiators, were 1.0 g/mol and 2.0 g/mol respectively, and the H₂O₂/NaPS was 0.50, and the MA/AA was 39/61.

As to the 80% AA, the 35% H₂O₂, and the pure water, their respective entireties were dropped continuously over a period of 120 minutes since the start of the polymerization. As to the 15% NaPS, its entirety was dropped continuously over a period of 130 minutes since the start of the polymerization. In this period, the rate of the dropping (rate of addition) of the 15% NaPS was 0.92 g/mol·h.

Furthermore, the boiling point reflux state was maintained over a period of 50 minutes since the end of all the above droppings, thus completing the polymerization.

After the completion of the polymerization, the pH and the concentration were adjusted to obtain a water-soluble polymer (7) having a pH of 6.7 and a solid component concentration of 46 wt %.

The water-soluble polymer (7) had a calcium-ion-binding ability of 472 mgCaCO₃/g, a clay dispersibility of 1.26 under the hardness of 50 ppm, a clay dispersibility of 0.91 under the hardness of 100 ppm, and a weight-average molecular weight of 31,000. In addition, the water-soluble polymer (7) had a detergency of 46%.

The conditions and results of Example 7 are collectively shown in Table 2.

### EXAMPLE 8

An amount of 107.9 g of pure water, 325.0 g of 48% NaOH, and 191.1 g of anhydrous MA were initially charged into the same flask as of Example 1. The resultant aqueous solution was heated until coming into a boiling point reflux state while being stirred. Incidentally, the neutralization degree of the MA in the initially charged aqueous solution was 100 mol %.

Next, while the reflux state was maintained under stirred conditions, the following materials were dropped from their respective separate dropping nozzles: 274.5 g of 80% AA; 21.4 g of 35% H₂O₂; 100.0 g of 15% NaPS; and 181.6 g of pure water. Incidentally, the amounts of the above hydrogen peroxide and sodium persulfate, being used as the polymerization initiators, were 1.5 g/mol and 3.0 g/mol respectively, and the H₂O₂/NaPS was 0.50, and the MA/AA was 39/61.

As to the 80% AA, the 35% H₂O₂, and the pure water, their respective entireties were dropped continuously over a period of 120 minutes since the start of the polymerization. As to the 15% NAPS, its entirety was dropped continuously over a period of 130 minutes since the start of the polymerization. In this period, the rate of the dropping (rate of addition) of the 15% NaPS was 1.38 g/mol·h.

Furthermore, the boiling point reflux state was maintained over a period of 50 minutes since the end of all the above droppings, thus completing the polymerization.

After the completion of the polymerization, the pH and the concentration were adjusted to obtain a water-soluble polymer (8) having a pH of 6.8 and a solid component concentration of 45 wt %.

The water-soluble polymer (8) had a calcium-ion-binding ability of 474 mgCaCO₃/g, a clay dispersibility of 1.37 under the hardness of 50 ppm, a clay dispersibility of 0.99 under the hardness of 100 ppm, and a weight-average molecular weight of 23,000. In addition, the water-soluble polymer (8) had a detergency of 46%.

The conditions and results of Example 8 are collectively shown in Table 2.

### EXAMPLE 9

An amount of 170.0 g of pure water, 333.3 g of 48% NaOH, and 196.0 g of anhydrous MA were initially charged into the same flask as of Example 1. The resultant aqueous solution was heated until coming into a boiling point reflux state while being stirred. Incidentally, the neutralization degree of the MA in the initially charged aqueous solution was 100 mol %.

Next, while the reflux state was maintained under stirred conditions, the following materials were dropped from their respective separate dropping nozzles: 270.0 g of 80% AA; 14.3 g of 35% H₂O₂; 66.7 g of 15% NAPS; and 152.6 g of pure water. Incidentally, the amounts of the above hydrogen peroxide and sodium persulfate, being used as the polymerization initiators, were 1.0 g/mol and 2.0 g/mol respectively, and the H₂O₂/NaPS was 0.50, and the MA/AA was 40/60.

As to the 80% AA, its entirety was dropped continuously over a period of 120 minutes since the start of the polymerization. As to the 35% H₂O₂ and the pure water, their respective entireties were dropped continuously over a period of 90 minutes since the start of the polymerization. As to the 15% NAPS, its entirety was dropped continuously over a period of 130 minutes since the start of the polymerization. In this period, the rate of the dropping (rate of addition) of the 15%NAPS was 0.92 g/mol·h.

Furthermore, the boiling point reflux state was maintained over a period of 50 minutes since the end of all the above droppings, thus completing the polymerization.

After the completion of the polymerization, the pH and the concentration were adjusted to obtain a water-soluble polymer (9) having a pH of 6.8 and a solid component concentration of 45 wt %.

The water-soluble polymer (9) had a calcium-ion-binding ability of 480 mgCaCO₃/g, a clay dispersibility of 1.39 under the hardness of 50 ppm, a clay dispersibility of 0.87 under the hardness of 100 ppm, and a weight-average molecular weight of 24,000. In addition, the water-soluble polymer (9) had a detergency of 45%.

The conditions and results of Example 9 are collectively shown in Table 3.

### EXAMPLE 10

An amount of 170.0 g of pure water, 333.3 g of 48% NaOH, and 196.0 g of anhydrous MA were initially charged into the same flask as of Example 1. The resultant aqueous solution was heated until coming into a boiling point reflux state while being stirred. Incidentally, the neutralization degree of the MA in the initially charged aqueous solution was 100 mol %.

Next, while the reflux state was maintained under stirred conditions, the following materials were dropped from their respective separate dropping nozzles: 270.0 g of 80% AA; 14.3 g of 35% H₂O₂; 50.0 g of 15% NaPS; and 162.7 g of pure water. Incidentally, the amounts of the above hydrogen peroxide and sodium persulfate, being used as the polymerization initiators, were 1.0 g/mol and 1.5 g/mol respectively, and the H₂O₂/NaPS was 0.67, and the MA/AA was 40/60.

As to the 80% AA, its entirety was dropped continuously over a period of 120 minutes since the start of the polymerization. As to the 35% H₂O₂ and the pure water, their respective entireties were dropped continuously over a period of 90 minutes since the start of the polymerization. As to the 15% NaPS, its entirety was dropped continuously over a period of 130 minutes since the start of the polymerization. In this period, the rate of the dropping (rate of addition) of the 15%NaPS was 0.69 g/mol·h.

Furthermore, the boiling point reflux state was maintained over a period of 50 minutes since the end of all the above droppings, thus completing the polymerization.

After the completion of the polymerization, the pH and the concentration were adjusted to obtain a water-soluble polymer (10) having a pH of 6.8 and a solid component concentration of 45 wt %.

The water-soluble polymer (10) had a calcium-ion-binding ability of 481 mgCaCO₃/g, a clay dispersibility of 1.45 under the hardness of 50 ppm, a clay dispersibility of 0.86 under the hardness of 100 ppm, and a weight-average molecular weight of 26,000. In addition, the water-soluble polymer (10) had a detergency of 45%.

The conditions and results of Example 10 are collectively shown in Table 3.

### EXAMPLE 11

An amount of 110.7 g of pure water, 333.3 g of 48% NaOH, and 196.0 g of anhydrous MA were initially charged into the same flask as of Example 1. The resultant aqueous solution was heated until coming into a boiling point reflux state while being stirred. Incidentally, the neutralization degree of the MA in the initially charged aqueous solution was 100 mol %.

Next, while the reflux state was maintained under stirred conditions, the following materials were dropped from their respective separate dropping nozzles: 270.0 g of 80% AA; 6.5 g of 35% H₂O₂; 38.7 g of 15% NaPS; and 237.2 g of pure water. Incidentally, the amounts of the above hydrogen peroxide and sodium persulfate, being used as the polymerization initiators, were 0.5 g/mol and 1.2 g/mol respectively, and the H₂O₂/NaPS was 0.42, and the MA/AA was 40/60.

As to the 80% AA, its entirety was dropped continuously over a period of 120 minutes since the start of the polymerization. As to the 35% H₂O₂ and the pure water, their respective entireties were dropped continuously over a period of 90 minutes since the start of the polymerization. As to the 15% NaPS, its entirety was dropped continuously over a period of 130 minutes since the start of the polymerization. In this period, the rate of the dropping (rate of addition) of the 15% NAPS was 0.55 g/mol·h.

Furthermore, the boiling point reflux state was maintained over a period of 50 minutes since the end of all the above droppings, thus completing the polymerization.

After the completion of the polymerization, the pH and the concentration were adjusted to obtain a water-soluble polymer (11) having a pH of 6.9 and a solid component concentration of 45 wt %.

The water-soluble polymer (11) had a calcium-ion-binding ability of 460 mgCaCO₃/g, a clay dispersibility of 1.39 under the hardness of 50 ppm, a clay dispersibility of 0.87 under the hardness of 100 ppm, and a weight-average molecular weight of 32,000. In addition, the water-soluble polymer (11) had a detergency of 45%.

The conditions and results of Example 11 are collectively shown in Table 3.

### EXAMPLE 12

An amount of 52.5 g of pure water, 333.3 g of 48% NaOH, and 196.0 g of anhydrous MA were initially charged into the same flask as of Example 1. The resultant aqueous solution was heated until coming into a boiling point reflux state while being stirred. Incidentally, the neutralization degree of the MA in the initially charged aqueous solution was 100 mol %.

Next, while the reflux state was maintained under stirred conditions, the following materials were dropped from their respective separate dropping nozzles: 270.0 g of 80% AA; 14.3 g of 35% H₂O₂; 33.3 g of 15% NaPS; and 247.0 g of pure water. Incidentally, the amounts of the above hydrogen peroxide and sodium persulfate, being used as the polymerization initiators, were 1.0 g/mol and 1.0 g/mol respectively, and the H₂O₂/NaPS was 1.00, and the MA/AA was 40/60.

As to the 80% AA, its entirety was dropped continuously over a period of 120 minutes since the start of the polymerization. As to the 35% H₂O₂ and the pure water, their respective entireties were dropped continuously over a period of 90 minutes since the start of the polymerization. As to the 15% NAPS, its entirety was dropped continuously over a period of 130 minutes since the start of the polymerization. In this period, the rate of the dropping (rate of addition) of the 15% NAPS was 0.46 g/mol·h.

Furthermore, the boiling point reflux state was maintained over a period of 50 minutes since the end of all the above droppings, thus completing the polymerization.

After the completion of the polymerization, the pH and the concentration were adjusted to obtain a water-soluble polymer (12) having a pH of 6.9 and a solid component concentration of 47 wt %.

The water-soluble polymer (12) had a calcium-ion-binding ability of 460 mgCaCO₃/g, a clay dispersibility of 1.59 under the hardness of 50 ppm, a clay dispersibility of 0.87 under the hardness of 100 ppm, and a weight-average molecular weight of 30,000. In addition, the water-soluble polymer (12) had a detergency of 45%.

The conditions and results of Example 12 are collectively shown in Table 3.

### EXAMPLE 13

An amount of 52.5 g of pure water, 333.3 g of 48% NaOH, and 196.0 g of anhydrous MA were initially charged into the same flask as of Example 1. The resultant aqueous solution was heated until coming into a boiling point reflux state while being stirred. Incidentally, the neutralization degree of the MA in the initially charged aqueous solution was 100 mol %.

Next, while the reflux state was maintained under stirred conditions, the following materials were dropped from their respective separate dropping nozzles: 270.0 g of 80% AA; 14.3 g of 35% H₂O₂; 33.3 g of 15% NAPS; and 247.0 g of pure water. Incidentally, the amounts of the above hydrogen peroxide and sodium persulfate, being used as the polymerization initiators, were 1.0 g/mol and 1.0 g/mol respectively, and the H₂O₂/NaPS was 1.00, and the MA/AA was 40/60.

As to the 80% AA, its entirety was dropped continuously over a period of 120 minutes since the start of the polymerization. As to the 35% H₂O₂, its entirety was dropped continuously over a period of 90 minutes since the start of the polymerization. As to the pure water, its entirety was dropped continuously over a 40-minute-long period of from 90 minutes till 130 minutes after the start of the polymerization. As to the 15% NaPS, its entirety was dropped continuously over a period of 130 minutes since the start of the polymerization. In this period, the rate of the dropping (rate of addition) of the 15% NAPS was 0.46 g/mol·h.

Furthermore, the boiling point reflux state was maintained over a period of 50 minutes since the end of all the above droppings, thus completing the polymerization.

After the completion of the polymerization, the pH and the concentration were adjusted to obtain a water-soluble polymer (13) having a pH of 7.0 and a solid component concentration of 47 wt %.

The water-soluble polymer (13) had a calcium-ion-binding ability of 465 mgCaCO₃/g, a clay dispersibility of 1.49 under the hardness of 50 ppm, a clay dispersibility of 0.88 under the hardness of 100 ppm, and a weight-average molecular weight of 47,000. In addition, the water-soluble polymer (13) had a detergency of 45%.

The conditions and results of Example 13 are collectively shown in Table 3.

### EXAMPLE 14

An amount of 52.5 g of pure water, 333.3 g of 48% NaOH, and 196.0 g of anhydrous MA were initially charged into the same flask as of Example 1. The resultant aqueous solution was heated until coming into a boiling point reflux state while being stirred. Incidentally, the neutralization degree of the MA in the initially charged aqueous solution was 100 mol %.

Next, while the reflux state was maintained under stirred conditions, the following materials were dropped from their respective separate dropping nozzles: 270.0 g of 80% AA; 14.3 g of 35% H₂O₂; 33.3 g of 15% NAPS; and 247.0 g of pure water. Incidentally, the amounts of the above hydrogen peroxide and sodium persulfate, being used as the polymerization initiators, were 1.0 g/mol and 1.0 g/mol respectively, and the H₂O₂/NaPS was 1.00, and the MA/AA was 40/60.

As to the 80% AA, its entirety was dropped continuously over a period of 120 minutes since the start of the polymerization. As to the 35% H₂O₂, its entirety was dropped continuously over a period of 90 minutes since the start of the polymerization. As to the pure water, its entirety was dropped continuously over a 70-minute-long period of from 60 minutes till 130 minutes after the start of the polymerization. As to the 15% NaPS, its entirety was dropped continuously over a period of 130 minutes since the start of the polymerization. In this period, the rate of the dropping (rate of addition) of the 15% NaPS was 0.46 g/mol·h.

Furthermore, the boiling point reflux state was maintained over a period of 50 minutes since the end of all the above droppings, thus completing the polymerization.

After the completion of the polymerization, the pH and the concentration were adjusted to obtain a water-soluble polymer (14) having a pH of 6.9 and a solid component concentration of 47 wt %.

The water-soluble polymer (14) had a calcium-ion-binding ability of 468 mgCaCO₃/g, a clay dispersibility of 1.32 under the hardness of 50 ppm, a clay dispersibility of 0.98 under the hardness of 100 ppm, and a weight-average molecular weight of 39,000. In addition, the water-soluble polymer (14) had a detergency of 46%.

The conditions and results of Example 14 are collectively shown in Table 4.

### EXAMPLE 15

An amount of 52.5 g of pure water, 333.3 g of 48% NaOH, and 196.0 g of anhydrous MA were initially charged into the same flask as of Example 1. The resultant aqueous solution was heated until coming into a boiling point reflux state while being stirred. Incidentally, the neutralization degree of the MA in the initially charged aqueous solution was 100 mol %.

Next, while the reflux state was maintained under stirred conditions, the following materials were dropped from their respective separate dropping nozzles: 270.0 g of 80% AA; 10.0 g of 35% H₂O₂; 33.3 g of 15% NAPS; and 247.0 g of pure water. Incidentally, the amounts of the above hydrogen peroxide and sodium persulfate, being used as the polymerization initiators, were 0.7 g/mol and 1.0 g/mol respectively, and the H₂O₂/NaPS was 0.70, and the MA/AA was 40/60.

As to the 80% AA, its entirety was dropped continuously over a period of 120 minutes since the start of the polymerization. As to the 35% H₂O₂, its entirety was dropped continuously over a period of 90 minutes since the start of the polymerization. As to the pure water, its entirety was dropped continuously over a 70-minute-long period of from 60 minutes till 130 minutes after the start of the polymerization. As to the 15% NaPS, its entirety was dropped continuously over a period of 130 minutes since the start of the polymerization. In this period, the rate of the dropping (rate of addition) of the 15% NAPS was 0.46 g/mol·h.

Furthermore, the boiling point reflux state was maintained over a period of 50 minutes since the end of all the above droppings, thus completing the polymerization.

After the completion of the polymerization, the pH and the concentration were adjusted to obtain a water-soluble polymer (15) having a pH of 6.9 and a solid component concentration of 47 wt %.

The water-soluble polymer (15) had a calcium-ion-binding ability of 472 mgCaCO₃/g, a clay dispersibility of 1.38 under the hardness of 50 ppm, a clay dispersibility of 0.89 under the hardness of 100 ppm, and a weight-average molecular weight of 45,000. In addition, the water-soluble polymer (15) had a detergency of 45%.

The conditions and results of Example 15 are collectively shown in Table 4.

TABLE 1

| | | | Example 1 | Example 2 | Example 3 | Example 4 | Example 5 |
|---|---|---|---|---|---|---|---|
| Water-soluble polymer | | — | (1) | (2) | (3) | (4) | (5) |
| MA/AA | | — | 50/50 | 45/55 | 45/55 | 50/50 | 50/50 |
| Amount of | Pure water | g | 78.0 | 70.6 | 70.6 | 78.0 | 78.0 |
| initial | 48% NaOH | g | 283.3 | 255.0 | 255.0 | 283.3 | 283.3 |
| charging | Anhydrous MA | g | 196.0 | 176.4 | 176.4 | 196.0 | 196.0 |
| | Mohr's salt | g | — | — | — | 0.008 | — |
| Initial neutralization degree of MA | | mol % | 85 | 85 | 85 | 85 | 85 |
| Amount of | 80% AA | g | 180.0 | 198.0 | 198.0 | 180.0 | 180.0 |
| dropping | 35% H₂O₂ | g | 11.4 | 45.7 | 22.9 | 44.0 | 44.0 |
| | 15% NaPS | g | 32.0 | 80.0 | 53.3 | 53.3 | 53.3 |
| | Pure water | g | 200.0 | 131.8 | 173.4 | 173.4 | 173.4 |
| Amount of H₂O₂ being used | | g/mol | 1.0 | 4.0 | 2.0 | 3.85 | 3.85 |
| Amount of NaPS being used | | g/mol | 1.2 | 3.0 | 2.0 | 2.0 | 2.0 |
| H₂O₂/NaPS | | — | 0.83 | 1.33 | 1.00 | 1.92 | 1.92 |
| Period of | 80% AA | min | 0-120 | 0-120 | 0-120 | 0-120 | 0-120 |
| dropping | 35% H₂O₂ | min | 0-120 | 0-50 | 0-50 | 0-50 | 0-50 |
| | 15% NaPS | min | 0-150 | 0-130 | 0-130 | 50-130 | 50-130 |
| | Pure water | min | 0-150 | 0-50 | 0-50 | 50-130 | 50-130 |
| Rate of dropping of NaPS | | g/mol · h | 0.48 | 1.38 | 0.92 | 1.50 | 1.50 |
| Reaction temperature | | ° C. | Boiling | Boiling | Boiling | 95 | 95 |
| | | | point | point | point | | |
| Period of aging | | min | 30 | 20 | 20 | 20 | 20 |
| pH | | — | 7.5 | 7.5 | 7.5 | 7.5 | 7.5 |
| Solid component content | | wt % | 40 | 45 | 45 | 45 | 45 |
| Calcium-ion-binding ability | | mg/g | 454 | 436 | 452 | 450 | 450 |
| Clay | 50 ppm | — | 1.13 | 0.93 | 1.14 | 1.50 | 1.53 |
| dispersibility | 100 ppm | — | 0.95 | 1.20 | 0.82 | 0.33 | 0.28 |

| | | | | | | |
|---|---|---|---|---|---|---|
| Weight-average molecular weight | — | 27300 | 12300 | 17000 | 13400 | 15900 |
| Detergency | % | — | 45 | 45 | — | — |

TABLE 2

| | | | | Comparative | Comparative | | |
|---|---|---|---|---|---|---|---|
| | | | Example 6 | Example 1 | Example 2 | Example 7 | Example 8 |
| Water-soluble polymer | | — | (6) | (A) | (B) | (7) | (8) |
| MA/AA | | — | 60/40 | 50/50 | 30/70 | 39/61 | 39/61 |
| Amount of | Pure water | g | 61.0 | 132.8 | 83.0 | 107.9 | 107.9 |
| initial | 48% NaOH | g | 300.0 | 400.0 | 250.0 | 325.0 | 325.0 |
| charging | Anhydrous MA | g | 235.2 | 235.2 | 147.0 | 191.1 | 191.1 |
| | Mohr's salt | g | — | — | — | — | — |
| Initial neutralization degree of MA | | mol % | 75 | 100 | 100 | 100 | 100 |
| Amount of | 80% AA | g | 144.0 | 216.0 | 315.0 | 274.5 | 274.5 |
| dropping | 35% H₂O₂ | g | 68.6 | 57.6 | — | 14.3 | 21.4 |
| | 15% NaPS | g | 53.3 | 96.0 | 66.7 | 66.7 | 100.0 |
| | Pure water | g | 101.0 | 160.0 | 393.3 | 200.0 | 181.6 |
| Amount of H₂O₂ being used | | g/mol | 6.0 | 4.2 | 0 | 1.0 | 1.5 |
| Amount of NaPS being used | | g/mol | 2.0 | 3.0 | 2.0 | 2.0 | 3.0 |
| H₂O₂/NaPS | | — | 3.00 | 1.40 | 0 | 0.50 | 0.50 |
| Period of | 80% AA | min | 0-120 | 0-180 | 0-120 | 0-120 | 0-120 |
| dropping | 35% H₂O₂ | min | 0-50 | 0-50 | — | 0-120 | 0-120 |
| | 15% NaPS | min | 50-130 | 90-190 | 0-130 | 0-130 | 0-130 |
| | Pure water | min | 0-50 | 90-190 | 0-130 | 0-120 | 0-120 |
| Rate of dropping of NaPS | | g/mol · h | 1.50 | 1.80 | 0.92 | 0.92 | 1.38 |
| Reaction temperature | | ° C. | Boiling | Boiling | Boiling | Boiling | Boiling |
| | | | point | point | point | point | point |
| Period of aging | | min | 20 | 30 | 30 | 50 | 50 |
| pH | | — | 7.5 | 7.5 | 7.5 | 6.7 | 6.8 |
| Solid component content | | wt % | 50 | 45 | 40 | 46 | 45 |
| Calcium-ion-binding ability | | mg/g | 456 | 460 | 468 | 472 | 474 |
| Clay | 50 ppm | — | 1.22 | 1.25 | 0.75 | 1.26 | 1.37 |
| dispersibility | 100 ppm | — | — | 0.40 | 0.57 | 0.91 | 0.99 |

| | | | | | | |
|---|---|---|---|---|---|---|
| Weight-average molecular weight | — | 9300 | 10000 | 50000 | 31000 | 23000 |
| Detergency | % | — | 43 | 39 | 46 | 46 |

TABLE 3

| | | | Example 9 | Example 10 | Example 11 | Example 12 | Example 13 |
|---|---|---|---|---|---|---|---|
| Water-soluble polymer | | — | (9) | (10) | (11) | (12) | (13) |
| MA/AA | | — | 40/60 | 40/60 | 40/60 | 40/60 | 40/60 |
| Amount of | Pure water | g | 170.0 | 170.0 | 110.7 | 52.5 | 52.5 |
| initial | 48% NaOH | g | 333.3 | 333.3 | 333.3 | 333.3 | 333.3 |
| charging | Anhydrous MA | g | 196.0 | 196.0 | 196.0 | 196.0 | 196.0 |
| | Mohr's salt | g | — | — | — | — | — |
| Initial neutralization degree of MA | | mol % | 100 | 100 | 100 | 100 | 100 |
| Amount of | 80% AA | g | 270.0 | 270.0 | 270.0 | 270.0 | 270.0 |
| dropping | 35% H₂O₂ | g | 14.3 | 14.3 | 6.5 | 143 | 14.3 |
| | 15% NaPS | g | 66.7 | 50.0 | 38.7 | 33.3 | 33.3 |
| | Pure water | g | 152.6 | 162.7 | 237.2 | 247.0 | 247.0 |
| Amount of H₂O₂ being used | | g/mol | 1.0 | 1.0 | 0.5 | 1.0 | 1.0 |
| Amount of NaPS being used | | g/mol | 2.0 | 1.5 | 1.2 | 1.0 | 1.0 |
| H₂O₂/NaPS | | — | 0.50 | 0.67 | 0.42 | 1.00 | 1.00 |
| Period of | 80% AA | min | 0-120 | 0-120 | 0-120 | 0-120 | 0-120 |
| dropping | 35% H₂O₂ | min | 0-90 | 0-90 | 0-90 | 0-90 | 0-90 |
| | 15% NaPS | min | 0-130 | 0-130 | 0-130 | 0-130 | 0-130 |
| | Pure water | min | 0-90 | 0-90 | 0-90 | 0-90 | 90-130 |
| Rate of dropping of NaPS | | g/mol · h | 0.92 | 0.69 | 0.55 | 0.46 | 0.46 |
| Reaction temperature | | ° C. | Boiling | Boiling | Boiling | Boiling | Boiling |
| | | | point | point | point | point | point |
| Period of aging | | min | 50 | 50 | 50 | 50 | 50 |
| pH | | — | 6.8 | 6.8 | 6.9 | 6.9 | 7.0 |
| Solid component content | | wt % | 45 | 45 | 45 | 47 | 47 |
| Calcium-ion-binding ability | | mg/g | 480 | 481 | 460 | 460 | 465 |
| Clay | 50 ppm | — | 1.39 | 1.45 | 1.39 | 1.59 | 1.49 |
| dispersibility | 100 ppm | — | 0.87 | 0.86 | 0.87 | 0.87 | 0.88 |

| | | | | | | |
|---|---|---|---|---|---|---|
| Weight-average molecular weight | — | 24000 | 26000 | 32000 | 30000 | 47000 |
| Detergency | % | 45 | 45 | 45 | 45 | 45 |

TABLE 4

| | | | Example | Example |
|---|---|---|---|---|
| | | | 14 | 15 |
| Water-soluble polymer | | — | (14) | (15) |
| MA/AA | | — | 40/60 | 40/60 |
| Amount of | Pure water | g | 52.5 | 52.5 |
| initial | 48% NaOH | g | 333.3 | 333.3 |
| charging | Anhydrous MA | g | 196.0 | 196.0 |
| | Mohr's salt | g | — | — |
| Initial neutralization degree of MA | | mol % | 100 | 100 |
| Amount of | 80% AA | g | 270.0 | 270.0 |
| dropping | 35% H₂O₂ | g | 14.3 | 10.0 |
| | 15% NaPS | g | 33.3 | 33.3 |
| | Pure water | g | 247.0 | 247.0 |
| Amount of H₂O₂ being used | | g/mol | 1.0 | 0.7 |
| Amount of NaPS being used | | g/mol | 1.0 | 1.0 |
| H₂O₂/NaPS | | — | 1.00 | 0.70 |
| Period of | 80% AA | mm | 0-120 | 0-120 |
| dropping | 35% H₂O₂ | mm | 0-90 | 0-90 |
| | 15% NaPS | mm | 0-130 | 0-130 |
| | Pure water | mm | 60-130 | 60-130 |
| Rate of dropping of NaPS | | g/mol · h | 0.46 | 0.46 |
| Reaction temperature | | ° C. | Boiling | Boiling |
| | | | point | point |
| Period of aging | | min | 50 | 50 |
| pH | | — | 6.9 | 6.9 |
| Solid component content | | wt % | 47 | 47 |
| Calcium-ion-binding ability | | mg/g | 468 | 472 |
| Clay | 50 ppm | — | 1.32 | 1.38 |
| dispersibility | 100 ppm | — | 0.98 | 0.89 |

| | | | |
|---|---|---|---|
| Weight-average molecular weight | — | 39000 | 45000 |
| Detergency | % | 46 | 45 |

### INDUSTRIAL APPLICATION

The water-soluble polymer according to the present invention is, for example, favorable for a wide range of various uses such as detergent compositions, dispersants, flocculants, scale inhibitors, chelating agents, water-treating agents, and fiber-treating agents.

The production process according to the present invention is favorable as a process for producing the water-soluble polymer according to the present invention with ease and good productivity.

1. A water-soluble polymer, which has a calcium-ion-binding ability of not less than 470 mgCaCO₃/g and further has a clay dispersibility of not less than 0.90 in a test liquid having a calcium concentration of 50 ppm in terms of calcium carbonate.

2. A water-soluble polymer, which has a calcium-ion-binding ability of not less than 430 mgCaCO₃/g and further has a clay dispersibility of not less than 0.70 in a test liquid having a calcium concentration of 100 ppm in terms of calcium carbonate.

3. A water-soluble polymer according to claim 1, which has a weight-average molecular weight of 50,000-8,000.

4. A water-soluble polymer according to claim 1, which is a water-soluble polycarboxylic polymer containing, as an essential structural unit or essential structural units, a structural unit (M) derived from a monoethylenically unsaturated monocarboxylic acid (salt) monomer and/or a structural unit (D) derived from a monoethylenically unsaturated dicarboxylic acid (salt) monomer.

5. A water-soluble polymer according to claim 4, which has both the structural units (M) and (D), wherein the total content of these two structural units is not lower than 90 weight %, and wherein the mutual molar ratio between them (D/M) is in the range of 35/65 to 65/35.

6. A water-soluble polymer according to claim 5, wherein the molar ratio (D/M) is in the range of 40/60 to 60/40.

7. A process for production of a water-soluble polymer, which is a process comprising the step of polymerizing a monomer component to thereby obtain the water-soluble polymer, wherein the monomer component essentially includes a monoethylenically unsaturated monocarboxylic acid (salt) monomer (m) and/or a monoethylenically unsaturated dicarboxylic acid (salt) monomer (d); wherein:
the polymerization is carried out with at least two polymerization initiators essentially including hydrogen peroxide, and the reaction temperature in this polymerization is set in the range of 99-80° C.

8. A process for production of a water-soluble polymer, which is a process comprising the step of polymerizing a monomer component to thereby obtain the water-soluble polymer, wherein the monomer component essentially includes a monoethylenically unsaturated monocarboxylic acid (salt) monomer (m) and/or a monoethylenically unsaturated dicarboxylic acid (salt) monomer (d); wherein:
the molar ratio between the monomers (m) and (d) (d/m) is in the range of 35/65 to 65/35;
the polymerization is carried out with at least two polymerization initiators essentially including hydrogen peroxide, and the monomer (d) charged before addition of the polymerization initiators has a neutralization degree of 70 to 95 mol %; and
the weight ratio between hydrogen peroxide and the other initiators (hydrogen peroxide/other initiators) in the polymerization initiators in the polymerization is set at not less than 1.80, and/or the rate of the other initiators being added is set at not more than 1.40 g/mol·h.

9. A process for production of a water-soluble polymer, which is a process comprising the step of polymerizing a monomer component to thereby obtain the water-soluble polymer, wherein the monomer component essentially includes a monoethylenically unsaturated monocarboxylic acid (salt) monomer (m) and/or a monoethylenically unsaturated dicarboxylic acid (salt) monomer (d); wherein:
the molar ratio between the monomers (m) and (d) (d/m) is in the range of 35/65 to 65/35;
the polymerization is carried out with at least two polymerization initiators essentially including hydrogen peroxide, and the monomer (d) charged before addition of the polymerization initiators has a neutralization degree of not less than 90 mol %; and
the weight ratio between hydrogen peroxide and the other initiators (hydrogen peroxide/other initiators) in the polymerization initiators in the polymerization is set in the range of 0.4 to 1.1.

10. A detergent composition, which comprises, as an essential component, the water-soluble polymer as recited in any one of claims 1 to 6.

11. A dispersant, which comprises, as an essential component, the water-soluble polymer as recited in any one of claims 1 to 6.

12. A water-treating agent, which comprises, as an essential component, the water-soluble polymer as recited in any one of claims 1 to 6.

13. A water-soluble polymer according to claim 2, which has a weight-average molecular weight of 50,000-8,000.

14. A water-soluble polymer according to claim 2, which is a water-soluble polycarboxylic polymer containing, as an essential structural unit or essential structural units, a structural unit (M) derived from a monoethylenically unsaturated monocarboxylic acid (salt) monomer and/or a structural unit (D) derived from a monoethylenically unsaturated dicarboxylic acid (salt) monomer.

15. A water-soluble polymer according to claim 3, which is a water-soluble polycarboxylic polymer containing, as an essential structural unit or essential structural units, a structural unit (M) derived from a monoethylenically unsaturated monocarboxylic acid (salt) monomer and/or a structural unit (D) derived from a monoethylenically unsaturated dicarboxylic acid (salt) monomer.

16. A water-soluble polymer according to claim 13, which is a water-soluble polycarboxylic polymer containing, as an essential structural unit or essential structural units, a structural unit (M) derived from a monoethylenically unsaturated monocarboxylic acid (salt) monomer and/or a structural unit (D) derived from a monoethylenically unsaturated dicarboxylic acid (salt) monomer.

17. A water-soluble polymer according to claim 14, which has both the structural units (M) and (D), wherein the total content of these two structural units is not lower than 90 weight %, and wherein the mutual molar ratio between them (D/M) is in the range of 35/65 to 65/35.

18. A water-soluble polymer according to claim 15, which has both the structural units (M) and (D), wherein the total content of these two structural units is not lower than 90 weight %, and wherein the mutual molar ratio between them (D/M) is in the range of 35/65 to 65/35.

19. A water-soluble polymer according to claim 16, which has both the structural units (M) and (D), wherein the total content of these two structural units is not lower than 90 weight %, and wherein the mutual molar ratio between them (D/M) is in the range of 35/65 to 65/35.

20. A water-soluble polymer according to claim 17, wherein the molar ratio (D/M) is in the range of 40/60 to 60/40.

21. A water-soluble polymer according to claim 18, wherein the molar ratio (D/M) is in the range of 40/60 to 60/40.

22. A water-soluble polymer according to claim 19, wherein the molar ratio (D/M) is in the range of 40/60 to 60/40.

23. A detergent composition, which comprises, as an essential component, the water-soluble polymer as recited in any one of claims 13 to 22.

24. A dispersant, which comprises, as an essential component, the water-soluble polymer as recited in any one of claims 13 to 22.

25. A water-treating agent, which comprises, as an essential component, the water-soluble polymer as recited in any one of claims 13 to 22.
